(19) United States
(12) Patent Application Publication
(10) Pub. No.: US 2015/0049821 A1
(43) Pub. Date: Feb. 19, 2015

(54) IN-LOOP DEPTH MAP FILTERING FOR 3D VIDEO CODING

(71) Applicant: QUALCOMM Incorporated, San Diego, CA (US)

(72) Inventors: Ying Chen, San Diego, CA (US); Li Zhang, San Diego, CA (US)

(21) Appl. No.: 14/458,938

(22) Filed: Aug. 13, 2014

Related U.S. Application Data
(60) Provisional application No. 61/866,974, filed on Aug. 16, 2013.

(51) Int. Cl. H04N 19/80; H04N 13/00; H04N 19/176

(52) U.S. Cl. CPC H04N 19/0089; H04N 19/00278; H04N 13/0018
USPC 375/240.24

(57) ABSTRACT

This disclosure describes techniques for in-loop depth map filtering for 3D video coding processes. In one example, a method of decoding video data comprises decoding a depth block corresponding to a texture block, receiving a respective indication of one or more offset values for the decoded depth block, and performing a filtering process on edge pixels of the depth block using at least one of the one or more offset values to create a filtered depth block.

This application claims the benefit of U.S. Provisional Application No. 61/866,974, filed Aug. 16, 2013, the entire contents of which are incorporated by reference herein.

### TECHNICAL FIELD

This disclosure relates to video coding, and more particularly to techniques for in-loop depth map filtering for 3D video coding processes.

### BACKGROUND

Digital video capabilities can be incorporated into a wide range of devices, including digital televisions, digital direct broadcast systems, wireless broadcast systems, personal digital assistants (PDAs), laptop or desktop computers, tablet computers, e-book readers, digital cameras, digital recording devices, digital media players, video gaming devices, video game consoles, cellular or satellite radio telephones, so-called “smart phones,” video teleconferencing devices, video streaming devices, and the like. Digital video devices implement video coding techniques, such as those described in the standards defined by MPEG-2, MPEG-4, ITU-T H.263, ITU-T H.264/MPEG-4, Part 10, Advanced Video Coding (AVC), the High Efficiency Video Coding (HEVC) standard presently under development, and extensions of such standards. The video devices may transmit, receive, encode, decode, and/or store digital video information more efficiently by implementing such video coding techniques.

Video coding techniques include spatial (intra-picture) prediction and/or temporal (inter-picture) prediction to reduce or remove redundancy inherent in video sequences. For block-based video coding, a video slice (e.g., a video frame or a portion of a video frame) may be partitioned into video blocks, which may also be referred to as treeblocks, coding units (CUs) and/or coding nodes. Video blocks in an intra-coded (I) slice of a picture are encoded using spatial prediction with respect to reference samples in neighboring blocks in the same picture. Video blocks in an inter-coded (P or B) slice of a picture may use spatial prediction with respect to reference samples in neighboring blocks in the same picture or temporal prediction with respect to reference samples in other reference pictures. Pictures may be referred to as frames, and reference pictures may be referred to a reference frames.

Spatial or temporal prediction results in a predictive block for a block to be coded. Residual data represents pixel differences between the original block to be coded and the predictive block. An inter-coded block is encoded according to a motion vector that points to a block of reference samples forming the predictive block, and the residual data indicating the difference between the coded block and the predictive block. An intra-coded block is encoded according to an intra-coding mode and the residual data. For further compression, the residual data may be transformed from the pixel domain to a transform domain, resulting in residual transform coefficients, which then may be quantized. The quantized transform coefficients, initially arranged in a two-dimensional array, may be scanned in order to produce a one-dimensional vector of transform coefficients, and entropy coding may be applied to achieve even more compression.

### SUMMARY

In general, this disclosure describes techniques for in-loop depth map filtering for three-dimensional (3D) video coding processes.

In one example of the disclosure, a method of decoding video data comprises decoding a depth block corresponding to a texture block, receiving a respective indication of one or more offset values for the decoded depth block, and performing a filtering process on edge pixels of the depth block using at least one of the one or more offset values to create a filtered depth block.

In another example of the disclosure, a method of encoding video data comprises reconstructing a depth block corresponding to a texture block, performing a filtering process on edge pixels of the depth block using at least one of the one or more offset values to create a filtered depth block, and generating a respective indication of one or more offset values for the reconstructed depth block.

In another example of the disclosure, an apparatus configured to decode video data comprises a memory configured to store video data, including at least a depth block and a texture block, and a video decoder configured to decode the depth block corresponding to the texture block, receive a respective indication of one or more offset values for the decoded depth block, and perform a filtering process on edge pixels of the depth block using at least one of the one or more offset values to create a filtered depth block.

In another example of the disclosure, an apparatus configured to decode video data comprises means for decoding a depth block corresponding to a texture block, means for receiving a respective indication of one or more offset values for the decoded depth block, and means for performing a filtering process on edge pixels of the depth block using at least one of the one or more offset values to create a filtered depth block.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example video encoding and decoding system that may utilize the techniques of this disclosure.

FIG. 2 is a conceptual diagram illustrating an example decoding order for multi-view video.

FIG. 3 is a conceptual diagram illustrating an example prediction structure for multi-view video.

FIG. 4 is a conceptual diagram illustrating texture and depth values for 3D video.

FIG. 5 is a conceptual diagram illustrating a view synthesis optimization technique.

FIG. 6 is a conceptual diagram illustrating an example band classification based offset type including a central band and a side band.

FIG. 7 is a conceptual diagram illustrating four possible edge offset classifications.

FIG. 8 is a flowchart illustrating an example adaptive depth edge filtering process.

FIG. 9 illustrates an example of the pixel locations that are detected as edge-like pixels and filtered.

FIG. 10 is a block diagram illustrating an example of a video encoder that may implement the techniques of this disclosure.

FIG. 11 is a block diagram illustrating an example of a video decoder that may implement the techniques of this disclosure.

FIG. 12 is a flowchart illustrating an example encoding process according to the techniques of the disclosure.

FIG. 13 is a flowchart illustrating an example decoding process according to the techniques of the disclosure.

### DETAILED DESCRIPTION

In general, this disclosure describes techniques for the improving the quality of depth maps after depth pixels have been reconstructed in a three-dimensional (3D) video coding process. In particular, this disclosure describes in-loop filtering techniques on reconstructed depth pixels in order to improve the depth map quality, which may reduce distortion in synthesized views.

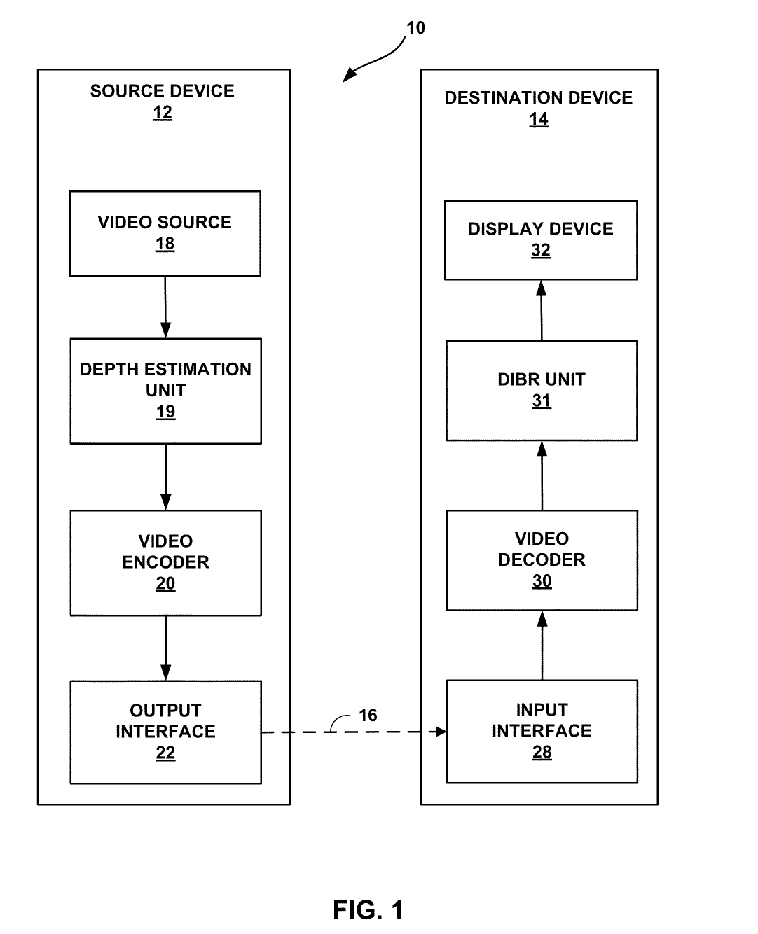

FIG. 1 is a block diagram illustrating an example video encoding and decoding system 10 that may utilize the techniques of this disclosure for filtering depth maps in a 3D video coding process. As shown in FIG. 1, system 10 includes a source device 12 that provides encoded video data to be decoded at a later time by a destination device 14. In particular, source device 12 provides the video data to destination device 14 via a computer-readable medium 16. Source device 12 and destination device 14 may comprise any of a wide range of devices, including desktop computers, notebook (e.g., laptop) computers, tablet computers, set-top boxes, telephone handsets such as so-called “smart” phones, so-called “smart” pads, televisions, cameras, display devices, digital media players, video gaming consoles, video streaming device, or the like. In some cases, source device 12 and destination device 14 may be equipped for wireless communication.

Destination device 14 may receive the encoded video data to be decoded via computer-readable medium 16. Computer-readable medium 16 may comprise any type of medium or device capable of moving the encoded video data from source device 12 to destination device 14. In one example, computer-readable medium 16 may comprise a communication medium to enable source device 12 to transmit encoded video data directly to destination device 14 in real-time. The encoded video data may be modulated according to a communication standard, such as a wireless communication protocol, and transmitted to destination device 14. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 12 to destination device 14.

In some examples, encoded data may be output from output interface 22 to a storage device. Similarly, encoded data may be accessed from the storage device by input interface. The storage device may include any of a variety of distributed or locally accessed data storage media such as a hard drive, Blu-ray discs, DVDs, CD-ROMs, flash memory, volatile or non-volatile memory, or any other suitable digital storage media for storing encoded video data. In a further example, the storage device may correspond to a file server or another intermediate storage device that may store the encoded video generated by source device 12. Destination device 14 may access stored video data from the storage device via streaming or download. The file server may be any type of server capable of storing encoded video data and transmitting that encoded video data to the destination device 14. Example file servers include a web server (e.g., for a website), an FTP server, network attached storage (NAS) devices, or a local disk drive. Destination device 14 may access the encoded video data through any standard data connection, including an Internet connection. This may include a wireless channel (e.g., a Wi-Fi connection), a wired connection (e.g., DSL, cable modem, etc.), or a combination of both that is suitable for accessing encoded video data stored on a file server. The transmission of encoded video data from the storage device may be a streaming transmission, a download transmission, or a combination thereof

The techniques of this disclosure for filtering depth maps in a 3D video coding process are not necessarily limited to wireless applications or settings. The techniques may be applied to video coding in support of any of a variety of multimedia applications, such as over-the-air television broadcasts, cable television transmissions, satellite television transmissions, Internet streaming video transmissions, such as dynamic adaptive streaming over HTTP (DASH), digital video that is encoded onto a data storage medium, decoding of digital video stored on a data storage medium, or other applications. In some examples, system 10 may be configured to support one-way or two-way video transmission to support applications such as video streaming, video playback, video broadcasting, and/or video telephony.

In the example of FIG. 1, source device 12 includes video source 18, depth estimation unit 19, video encoder 20, and output interface 22. Destination device 14 includes input interface 28, video decoder 30, depth image based rendering (DIBR) unit 31, and display device 32. In other examples, a source device and a destination device may include other components or arrangements. For example, source device 12 may receive video data from an external video source 18, such as an external camera. Likewise, destination device 14 may interface with an external display device, rather than including an integrated display device.

The illustrated system 10 of FIG. 1 is merely one example. The techniques of this disclosure may be performed by any digital video encoding and/or decoding device. Although generally the techniques of this disclosure are performed by a video encoding device, the techniques may also be performed by a video encoder/decoder, typically referred to as a “CODEC.” Moreover, the techniques of this disclosure may also be performed by a video preprocessor. Source device 12 and destination device 14 are merely examples of such coding devices in which source device 12 generates coded video data for transmission to destination device 14. In some examples, devices 12 and 14 may operate in a substantially symmetrical manner such that each of devices 12 and 14 include video encoding and decoding components. Hence, system 10 may support one-way or two-way video transmission between video devices 12 and 14, e.g., for video streaming, video playback, video broadcasting, or video telephony.

Video source 18 of source device 12 may include a video capture device, such as a video camera, a video archive containing previously captured video, and/or a video feed interface to receive video from a video content provider. As a further alternative, video source 18 may generate computer graphics-based data as the source video, or a combination of live video, archived video, and computer-generated video. In some cases, if video source 18 is a video camera, source device 12 and destination device 14 may form so-called camera phones or video phones. As mentioned above, however, the techniques described in this disclosure may be applicable to video coding in general, and may be applied to wireless and/or wired applications. In each case, the captured, pre-captured, or computer-generated video may be encoded by video encoder 20. The encoded video information may then be output by output interface 22 onto a computer-readable medium 16.

Video source 18 may provide multiple views of video data to video encoder 20. For example, video source 18 may correspond to an array of cameras, each having a unique horizontal position relative to a particular scene being filmed. Alternatively, video source 18 may generate video data from disparate horizontal camera perspectives, e.g., using computer graphics. Depth estimation unit 19 may be configured to determine values for depth pixels corresponding to pixels in a texture image. For example, depth estimation unit 19 may represent a Sound Navigation and Ranging (SONAR) unit, a Light Detection and Ranging (LIDAR) unit, or other unit capable of directly determining depth values substantially simultaneously while recording video data of a scene.

Additionally or alternatively, depth estimation unit 19 may be configured to calculate depth values indirectly by comparing two or more images that were captured at substantially the same time from different horizontal camera perspectives. By calculating horizontal disparity between substantially similar pixel values in the images, depth estimation unit 19 may approximate depth of various objects in the scene. Depth estimation unit 19 may be functionally integrated with video source 18, in some examples. For example, when video source 18 generates computer graphics images, depth estimation unit 19 may provide actual depth maps for graphical objects, e.g., using z-coordinates of pixels and objects used to render texture images.

Computer-readable medium 16 may include transient media, such as a wireless broadcast or wired network transmission, or storage media (that is, non-transitory storage media), such as a hard disk, flash drive, compact disc, digital video disc, Blu-ray disc, or other computer-readable media. In some examples, a network server (not shown) may receive encoded video data from source device 12 and provide the encoded video data to destination device 14, e.g., via network transmission. Similarly, a computing device of a medium production facility, such as a disc stamping facility, may receive encoded video data from source device 12 and produce a disc containing the encoded video data. Therefore, computer-readable medium 16 may be understood to include one or more computer-readable media of various forms, in various examples.

Input interface 28 of destination device 14 receives information from computer-readable medium 16. The information of computer-readable medium 16 may include syntax information defined by video encoder 20, which is also used by video decoder 30, that includes syntax elements that describe characteristics and/or processing of blocks and other coded units, e.g., GOPs. Display device 32 displays the decoded video data to a user, and may comprise any of a variety of display devices such as a cathode ray tube (CRT), a liquid crystal display (LCD), a plasma display, an organic light emitting diode (OLED) display, or another type of display device. In some examples, display device 32 may comprise a device capable of displaying two or more views simultaneously or substantially simultaneously, e.g., to produce a 3D visual effect for a viewer.

DIBR unit 31 of destination device 14 may render synthesized views using texture and depth information of decoded views received from video decoder 30. For example, DIBR unit 31 may determine horizontal disparity for pixel data of texture images as a function of values of pixels in corresponding depth maps. DIBR unit 31 may then generate a synthesized image by offsetting pixels in a texture image left or right by the determined horizontal disparity. In this manner, display device 32 may display one or more views, which may correspond to decoded views and/or synthesized views, in any combination. In accordance with the techniques of this disclosure, video decoder 30 may provide original and updated precision values for depth ranges and camera parameters to DIBR unit 31, which may use the depth ranges and camera parameters to properly synthesize views.

Although not shown in FIG. 1, in some aspects, video encoder 20 and video decoder 30 may each be integrated with an audio encoder and decoder, and may include appropriate MUX-DEMUX units, or other hardware and software, to handle encoding of both audio and video in a common data stream or separate data streams. If applicable, MUX-DEMUX units may conform to the ITU H.223 multiplexer protocol, or other protocols such as the user datagram protocol (UDP).

Video encoder 20 and video decoder 30 may operate according to a video coding standard, such as the High Efficiency Video Coding (HEVC) standard and may conform to the HEVC Test Model (HM). Alternatively, video encoder 20 and video decoder 30 may operate according to other proprietary or industry standards, such as the ITU-T H.264 standard, alternatively referred to as MPEG-4, Part 10, Advanced Video Coding (AVC), or extensions of such standards, such as the MVC extension of ITU-T H.264/AVC. In particular, the techniques of this disclosure are related to 3D video coding based on advanced codecs. In general, the techniques of this disclosure may be applied to any of a variety of different video coding standards. For example, these techniques may be applied to the multi-view video coding (MVC) extension of ITU-T H.264/AVC (advanced video coding), to a 3D video (3DV) extension of the HEVC standard (e.g., 3D-HEVC), or other coding standard.

Recently, the design of a new video coding standard, namely High-Efficiency Video Coding (HEVC), has been finalized by the Joint Collaboration Team on Video Coding (JCT-VC) of ITU-T Video Coding Experts Group (VCEG) and ISO/IEC Motion Picture Experts Group (MPEG). A recent draft of the HEVC standard, referred to as “HEVC Working Draft 10” or “WD10,” is described in document JCTVC-L1003v34, Bross et al., “High efficiency video coding (HEVC) text specification draft 10 (for FDIS & Last Call),” Joint Collaborative Team on Video Coding (JCT-VC) of ITU-T SG16 WP3 and ISO/IEC JTC1/SC29/WG11, 12th Meeting: Geneva, CH, 14-23 Jan., 2013, which, as of Jul. 26, 2013, is downloadable from: http://phenix.int-evrv.fr/jct/doc end user/documents/12 Geneva/wg11/JCTVC-L1003-v34.zip. Another draft of the HEVC standard, is referred to herein as “WD10 revisions” described in Bross et al., “Editors' proposed corrections to HEVC version 1,” Joint Collaborative Team on Video Coding (JCT-VC) of ITU-T SG16 WP3 and ISO/IEC JTC1/SC29/WG11, 13^{th} Meeting, Incheon, K R, April 2013, which as of Jul. 26, 2013, is available from: http://phenix.int-evey.fr/jct/doc_end_user/documents/13_Incheon/wg11/JCTVC-M0432-v3.zip.

A Joint Collaboration Team on 3D Video Coding (JCT-3C) of VCEG and MPEG is developing a 3DV standard based on HEVC, for which part of the standardization efforts includes the standardization of the multiview video codec based on HEVC (MV-HEVC) and another part for 3D Video coding based on HEVC (3D-HEVC). For MV-HEVC, it should be guaranteed that there are only high-level syntax (HLS) changes in it, such that no module in the CU/PU level in HEVC needs to be re-designed and can be fully reused for MV-HEVC. For 3D-HEVC, new coding tools, including those in coding unit/prediction unit level, for both texture and depth views (also called depth maps) may be included and supported.

One version of the reference software description, as well as the working draft of 3D-HEVC, is to available as follows: Gerhard Tech, Krzysztof Wegner, Ying Chen, Sehoon Yea, “3D-HEVC Test Model 4,” JCT3V-D1005_spec_v1, Joint Collaborative Team on 3D Video Coding Extension Development of ITU-T SG 16 WP 3 and ISO/IEC JTC 1/SC 29/WG 11, 4th Meeting: Incheon, KR, 20-26 Apr. 2013. HEVC Test Model 4 can be downloaded from the following link:http://phenix.it-sudparis.eu/jct2/doc_end_user/documents/4_Incheon/wg11/JCT3V-D1005-v1.zip. One version of the software 3D-HTM for 3D-HEVC can be downloaded from the following link: [3D-HTM version 7.0]: https://hevc.hhi.fraunhofer.de/syn/svn_{—}3DVCSoftware/tags/HTM-7.0/. An updated version of the of the reference software description, as well as the working draft of 3D-HEVC, is to available as follows: Gerhard Tech, Krzysztof Wegner, Ying Chen, Sehoon Yea, “3D-HEVC Draft Text 4,” JCT3V-H1001-v2, Joint Collaborative Team on 3D Video Coding Extension Development of ITU-T SG 16 WP 3 and ISO/IEC JTC 1/SC 29/WG 11, 8th Meeting: Valencia, ES, 29 Mar.-4 Apr. 2014.

Video encoder 20 and video decoder 30 each may be implemented as any of a variety of suitable encoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of video encoder 20 and video decoder 30 may be included in one or more encoders or decoders, either of which may be integrated as part of a combined encoder/decoder (CODEC) in a respective device. A device including video encoder 20 and/or video decoder 30 may comprise an integrated circuit, a microprocessor, and/or a wireless communication device, such as a cellular telephone.

As will be explained in more detail below, in one example of the disclosure, video encoder 20 and video decoder 30 may be configured to reconstruct/decode a depth block corresponding to a texture block, generate/receive a respective indication of one or more offset values for the decoded depth block, and perform a filtering process on edge pixels of the depth block using at least one of the one or more offset values to create a filtered depth block.

Initially, example coding techniques of HEVC will be discussed. The HEVC standardization efforts were based on an evolving model of a video coding device referred to as the HEVC Test Model (HM). The HM presumes several additional capabilities of video coding devices relative to existing devices according to, e.g., ITU-T H.264/AVC. For example, whereas H.264 provides nine intra-prediction encoding modes, the HM may provide as many as thirty-three angular intra-prediction encoding modes plus DC and Planar modes.

In general, the working model of the HM describes that a video frame or picture may be divided into a sequence of treeblocks or largest coding units (LCU) that include both luma and chroma samples. Syntax data within a bitstream may define a size for the LCU, which is a largest coding unit in terms of the number of pixels. A slice includes a number of consecutive treeblocks in coding order. A video frame or picture may be partitioned into one or more slices. Each treeblock may be split into coding units (CUs) according to a quadtree. In general, a quadtree data structure includes one node per CU, with a root node corresponding to the treeblock. If a CU is split into four sub-CUs, the node corresponding to the CU includes four leaf nodes, each of which corresponds to one of the sub-CUs.

Each node of the quadtree data structure may provide syntax data for the corresponding CU. For example, a node in the quadtree may include a split flag, indicating whether the CU corresponding to the node is split into sub-CUs. Syntax elements for a CU may be defined recursively, and may depend on whether the CU is split into sub-CUs. If a CU is not split further, it is referred as a leaf-CU. In this disclosure, four sub-CUs of a leaf-CU will also be referred to as leaf-CUs even if there is no explicit splitting of the original leaf-CU. For example, if a CU at 16×16 size is not split further, the four 8×8 sub-CUs will also be referred to as leaf-CUs although the 16×16 CU was never split.

A CU has a similar purpose as a macroblock of the H.264 standard, except that a CU does not have a size distinction. For example, a treeblock may be split into four child nodes (also referred to as sub-CUs), and each child node may in turn be a parent node and be split into another four child nodes. A final, unsplit child node, referred to as a leaf node of the quadtree, comprises a coding node, also referred to as a leaf-CU. Syntax data associated with a coded bitstream may define a maximum number of times a treeblock may be split, referred to as a maximum CU depth, and may also define a minimum size of the coding nodes. Accordingly, a bitstream may also define a smallest coding unit (SCU). This disclosure uses the term “block” to refer to any of a CU, PU, or TU, in the context of HEVC, or similar data structures in the context of other standards (e.g., macroblocks and sub-blocks thereof in H.264/AVC).

A CU includes a coding node and prediction units (PUs) and transform units (TUs) associated with the coding node. A size of the CU corresponds to a size of the coding node and must be square in shape. The size of the CU may range from 8×8 pixels up to the size of the treeblock with a maximum of 64×64 pixels or greater. Each CU may contain one or more PUs and one or more TUs. Syntax data associated with a CU may describe, for example, partitioning of the CU into one or more PUs. Partitioning modes may differ between whether the CU is skip or merge mode encoded, intra-prediction mode encoded, or inter-prediction mode encoded. PUs may be partitioned to be non-square in shape. Syntax data associated with a CU may also describe, for example, partitioning of the CU into one or more TUs according to a quadtree. A TU can be square or non-square (e.g., rectangular) in shape.

The HEVC standard allows for transformations according to TUs, which may be different for different CUs. The TUs are typically sized based on the size of PUs within a given CU defined for a partitioned LCU, although this may not always be the case. The TUs are typically the same size or smaller than the PUs. In some examples, residual samples corresponding to a CU may be subdivided into smaller units using a quadtree structure known as “residual quad tree” (RQT). The leaf nodes of the RQT may be referred to as transform units (TUs). Pixel difference values associated with the TUs may be transformed to produce transform coefficients, which may be quantized.

A leaf-CU may include one or more prediction units (PUs). In general, a PU represents a spatial area corresponding to all or a portion of the corresponding CU, and may include data for retrieving a reference sample for the PU. Moreover, a PU includes data related to prediction. For example, when the PU is intra-mode encoded, data for the PU may be included in a residual quadtree (RQT), which may include data describing an intra-prediction mode for a TU corresponding to the PU. As another example, when the PU is inter-mode encoded, the PU may include data defining one or more motion vectors for the PU. The data defining the motion vector for a PU may describe, for example, a horizontal component of the motion vector, a vertical component of the motion vector, a resolution for the motion vector (e.g., one-quarter pixel precision or one-eighth pixel precision), a reference picture to which the motion vector points, and/or a reference picture list (e.g., List 0, List 1, or List C) for the motion vector.

A leaf-CU having one or more PUs may also include one or more transform units (TUs). The transform units may be specified using an RQT (also referred to as a TU quadtree structure), as discussed above. For example, a split flag may indicate whether a leaf-CU is split into four transform units. Then, each transform unit may be split further into further sub-TUs. When a TU is not split further, it may be referred to as a leaf-TU. Generally, for intra coding, all the leaf-TUs belonging to a leaf-CU share the same intra prediction mode. That is, the same intra-prediction mode is generally applied to calculate predicted values for all TUs of a leaf-CU. For intra coding, a video encoder may calculate a residual value for each leaf-TU using the intra prediction mode, as a difference between the portion of the CU corresponding to the TU and the original block. A TU is not necessarily limited to the size of a PU. Thus, TUs may be larger or smaller than a PU. For intra coding, a PU may be collocated with a corresponding leaf-TU for the same CU. In some examples, the maximum size of a leaf-TU may correspond to the size of the corresponding leaf-CU.

Moreover, TUs of leaf-CUs may also be associated with respective quadtree data structures, referred to as residual quadtrees (RQTs). That is, a leaf-CU may include a quadtree indicating how the leaf-CU is partitioned into TUs. The root node of a TU quadtree generally corresponds to a leaf-CU, while the root node of a CU quadtree generally corresponds to a treeblock (or LCU). TUs of the RQT that are not split are referred to as leaf-TUs. In general, this disclosure uses the terms CU and TU to refer to leaf-CU and leaf-TU, respectively, unless noted otherwise.

A video sequence typically includes a series of video frames or pictures. A group of pictures (GOP) generally comprises a series of one or more of the video pictures. A GOP may include syntax data in a header of the GOP, a header of one or more of the pictures, or elsewhere, that describes a number of pictures included in the GOP. Each slice of a picture may include slice syntax data that describes an encoding mode for the respective slice. Video encoder 20 typically operates on video blocks within individual video slices in order to encode the video data. A video block may correspond to a coding node within a CU. The video blocks may have fixed or varying sizes, and may differ in size according to a specified coding standard.

As an example, the HM supports prediction in various PU sizes. Assuming that the size of a particular CU is 2N×2N, the HM supports intra-prediction in PU sizes of 2N×2N or N×N, and inter-prediction in symmetric PU sizes of 2N×2N, 2N×N, N×2N, or N×N. The HM also supports asymmetric partitioning for inter-prediction in PU sizes of 2N×nU, 2N×nD, nL×2N, and nR×2N. In asymmetric partitioning, one direction of a CU is not partitioned, while the other direction is partitioned into 25% and 75%. The portion of the CU corresponding to the 25% partition is indicated by an “n” followed by an indication of “Up”, “Down,” “Left,” or “Right.” Thus, for example, “2N×nU” refers to a 2N×2N CU that is partitioned horizontally with a 2N×0.5N PU on top and a 2N×1.5N PU on bottom.

In this disclosure, “N×N” and “N by N” may be used interchangeably to refer to the pixel dimensions of a video block in terms of vertical and horizontal dimensions, e.g., 16×16 pixels or 16 by 16 pixels. In general, a 16×16 block will have 16 pixels in a vertical direction (y=16) and 16 pixels in a horizontal direction (x=16). Likewise, an N×N block generally has N pixels in a vertical direction and N pixels in a horizontal direction, where N represents a nonnegative integer value. The pixels in a block may be arranged in rows and columns. Moreover, blocks need not necessarily have the same number of pixels in the horizontal direction as in the vertical direction. For example, blocks may comprise N×M pixels, where M is not necessarily equal to N.

Following intra-predictive or inter-predictive coding using the PUs of a CU, video encoder 20 may calculate residual data for the TUs of the CU. The PUs may comprise syntax data describing a method or mode of generating predictive pixel data in the spatial domain (also referred to as the pixel domain) and the TUs may comprise coefficients in the transform domain following application of a transform, e.g., a discrete cosine transform (DCT), an integer transform, a wavelet transform, or a conceptually similar transform to residual video data. The residual data may correspond to pixel differences between pixels of the unencoded picture and prediction values corresponding to the PUs. Video encoder 20 may form the TUs including the residual data for the CU, and then transform the TUs to produce transform coefficients for the CU.

Following any transforms to produce transform coefficients, video encoder 20 may perform quantization of the transform coefficients. Quantization generally refers to a process in which transform coefficients are quantized to possibly reduce the amount of data used to represent the coefficients, providing further compression. The quantization process may reduce the bit depth associated with some or all of the coefficients. For example, an n-bit value may be rounded down to an m-bit value during quantization, where n is greater than m.

Following quantization, the video encoder may scan the transform coefficients, producing a one-dimensional vector from the two-dimensional matrix including the quantized transform coefficients. The scan may be designed to place higher energy (and therefore lower frequency) coefficients at the front of the array and to place lower energy (and therefore higher frequency) coefficients at the back of the array. In some examples, video encoder 20 may utilize a predefined scan order to scan the quantized transform coefficients to produce a serialized vector that can be entropy encoded. In other examples, video encoder 20 may perform an adaptive scan. After scanning the quantized transform coefficients to form a one-dimensional vector, video encoder 20 may entropy encode the one-dimensional vector, e.g., according to context-adaptive variable length coding (CAVLC), context-adaptive binary arithmetic coding (CABAC), syntax-based context-adaptive binary arithmetic coding (SBAC), Probability Interval Partitioning Entropy (PIPE) coding or another entropy encoding methodology. Video encoder 20 may also entropy encode syntax elements associated with the encoded video data for use by video decoder 30 in decoding the video data.

To perform CABAC, video encoder 20 may assign a context within a context model to a symbol to be transmitted. The context may relate to, for example, whether neighboring values of the symbol are non-zero or not. To perform CAVLC, video encoder 20 may select a variable length code for a symbol to be transmitted. Codewords in VLC may be constructed such that relatively shorter codes correspond to more probable symbols, while longer codes correspond to less probable symbols. In this way, the use of VLC may achieve a bit savings over, for example, using equal-length codewords for each symbol to be transmitted. The probability determination may be based on a context assigned to the symbol.

In this section, multiview and multiview plus depth coding techniques will be discussed. Initially, MVC techniques will be discussed. As noted above, MVC is a multiview coding extension of ITU-T H.264/AVC. In MVC, data for a plurality of views is coded in time-first order, and accordingly, the decoding order arrangement is referred to as time-first coding. In particular, view components (that is, pictures) for each of the plurality of views at a common time instance may be coded, then another set of view components for a different time instance may be coded, and so on. An access unit may include coded pictures of all of the views for one output time instance. It should be understood that the decoding order of access units is not necessarily identical to the output (or display) order.

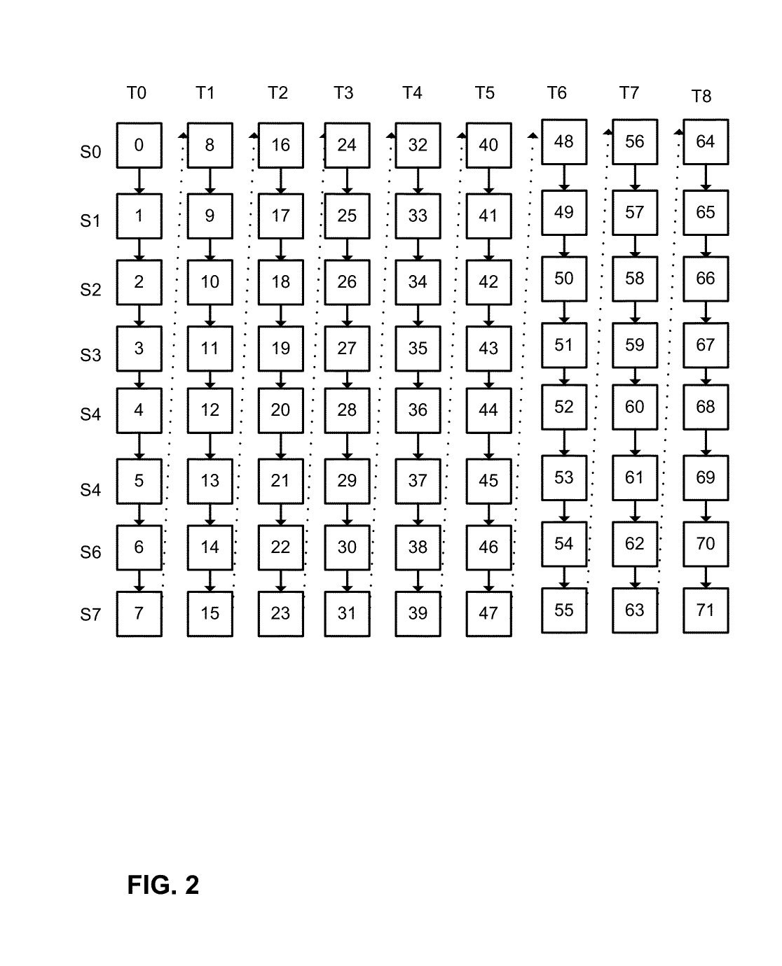

A typical MVC decoding order (i.e., a bitstream order) is shown in FIG. 2. The decoding order arrangement is referred as time-first coding. Note that the decoding order of access units may not be identical to the output order or display order of the access units. In FIG. 2, S0-S7 each refers to different views of the multiview video. T0-T8 each represents one output time instance. An access unit may include the coded pictures of all the views for one output time instance. For example, a first access unit may include all of the views S0-S7 for time instance T0, a second access unit may include all of the views S0-S7 for time instance T1, and so forth.

For purposes of brevity, the disclosure may use the following definitions:

view component: A coded representation of a view in a single access unit. When a view includes both a coded texture representation and a depth representation, a view component consists of a texture view component and a depth view component.

texture view component: A coded representation of the texture of a view in a single access unit.

depth view component: A coded representation of the depth of a view in a single access unit.

In FIG. 2, each of the views includes sets of pictures. For example, view S0 includes set of pictures 0, 8, 16, 24, 32, 40, 48, 56, and 64, view S1 includes set of pictures 1, 9, 17, 25, 33, 41, 49, 57, and 65, and so forth. Each set includes two types of pictures: one picture is referred to as a texture view component, and the other picture is referred to as a depth view component (also called a depth map). The texture view component and the depth view component within a set of pictures of a view may be considered as corresponding to one another. For example, the texture view component within a set of pictures of a view is considered as corresponding to the depth view component within the set of the pictures of the view, and vice-versa (i.e., the depth view component corresponds to its texture view component in the set, and vice-versa). As used in this disclosure, a texture view component that corresponds to a depth view component may be considered being part of a same view as the depth component in a single access unit.

The texture view component includes the actual image content that is displayed. For example, the texture view component may include luma (Y) and chroma (Cb and Cr) components. The depth view component may indicate relative depths of the pixels in the depth view component's corresponding texture view component. As one example, the depth view component is a gray scale image that includes only luma values. In other words, the depth view component may not convey any image content, but rather provide a measure of the relative depths of the pixels in the corresponding texture view component.

For example, a purely white pixel in the depth view component indicates that its corresponding pixel or pixels in the corresponding texture view component is closer from the perspective of the viewer, and a purely black pixel in the depth view component indicates that its corresponding pixel or pixels in the corresponding texture view component is further away from the perspective of the viewer. The various shades of gray in between black and white indicate different depth levels, such that an increase in the darkness of the shade of gray of a pixel in the depth view is indicative of an increase in the level of depth associated with the corresponding pixel in the texture view. For instance, a very gray pixel in the depth view component indicates that its corresponding pixel in the texture view component is further away than a slightly gray pixel in the depth view component. Because only gray scale is needed to identify the depth of pixels, the depth view component need not include chroma components, as color values for the depth view component may not serve any purpose.

The depth view component using only luma values (e.g., intensity values) to identify depth is provided for illustration purposes and should not be considered limiting. In other examples, any technique may be utilized to indicate relative depths of the pixels in the texture view component.

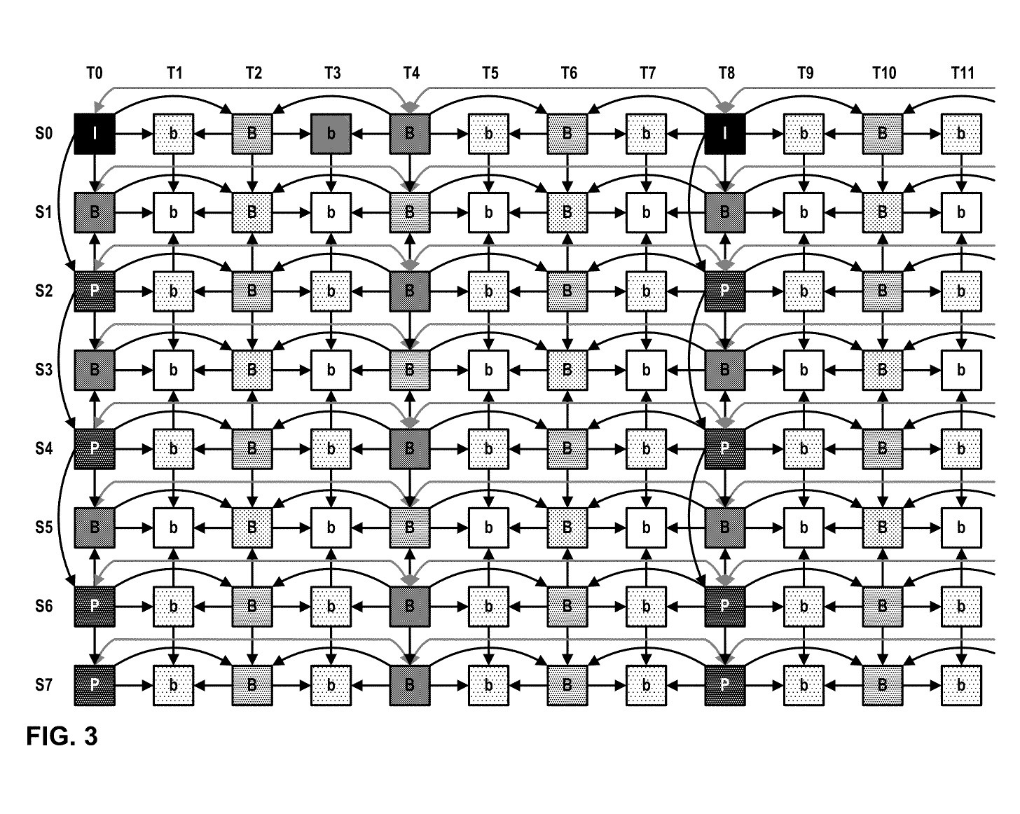

A typical MVC prediction structure (including both inter-picture prediction within each view and inter-view prediction) for multi-view video coding is shown in FIG. 3. Prediction directions are indicated by arrows, the pointed-to object using the pointed-from object as the prediction reference. In MVC, inter-view prediction is supported by disparity motion compensation, which uses the syntax of the H.264/AVC motion compensation, but allows a picture in a different view to be used as a reference picture.

In the example of FIG. 3, eight views (having view IDs “S0” through “S7”) are illustrated, and twelve temporal locations (“T0” through “T11”) are illustrated for each view. That is, each row in FIG. 3 corresponds to a view, while each column indicates a temporal location.

Although MVC has a so-called base view, which is decodable by H.264/AVC decoders, and stereo view pairs could be supported also by MVC, the advantage of MVC is that MVC can support an example that uses more than two views as a 3D video input and decodes this 3D video represented by the multiple views. A renderer of a client having an MVC decoder may expect 3D video content with multiple views.

Pictures in FIG. 3 are indicated at the intersection of each row and each column. The H.264/AVC standard may use the term frame to represent a portion of the video. This disclosure may use the term picture and frame interchangeably.

The pictures in FIG. 3 are illustrated using a block including a letter, the letter designating whether the corresponding picture is intra-coded (that is, an I-picture), or inter-coded in one direction (that is, as a P-picture) or in multiple directions (that is, as a B-picture). In general, predictions are indicated by arrows, where the pointed-to pictures use the pointed-from picture for prediction reference. For example, the P-picture of view S2 at temporal location T0 is predicted from the I-picture of view S0 at temporal location T0.

As with single view video encoding, pictures of a multiview video coding video sequence may be predictively encoded with respect to pictures at different temporal locations. For example, the b-picture of view S0 at temporal location T1 has an arrow pointed to it from the I-picture of view S0 at temporal location T0, indicating that the b-picture is predicted from the I-picture. Additionally, however, in the context of multiview video encoding, pictures may be inter-view predicted. That is, a view component can use the view components in other views for reference. In MVC, for example, inter-view prediction is realized as if the view component in another view is an inter-prediction reference. The potential inter-view references are signaled in the Sequence Parameter Set (SPS) MVC extension and can be modified by the reference picture list construction process, which enables flexible ordering of the inter-prediction or inter-view prediction references. Inter-view prediction is also a feature of a proposed multiview extension of HEVC, including 3D-HEVC (multiview plus depth).

FIG. 3 provides various examples of inter-view prediction. Pictures of view S1, in the example of FIG. 3, are illustrated as being predicted from pictures at different temporal locations of view S1, as well as inter-view predicted from pictures of views S0 and S2 at the same temporal locations. For example, the b-picture of view S1 at temporal location T1 is predicted from each of the B-pictures of view S1 at temporal locations T0 and T2, as well as the b-pictures of views S0 and S2 at temporal location T1.

In some examples, FIG. 3 may be viewed as illustrating the texture view components. For example, the I-, P-, B-, and b-pictures illustrated in FIG. 3 may be considered as texture view components for each of the views. In accordance with the techniques described in this disclosure, for each of the texture view components illustrated in FIG. 3 there is a corresponding depth view component. In some examples, the depth view components may be predicted in a manner similar to that illustrated in FIG. 3 for the corresponding texture view components.

Coding of two views could also be supported in MVC. One of the advantages of MVC is that an MVC encoder could take more than two views as a 3D video input and an MVC decoder can decode such a multiview representation. As such, any renderer with an MVC decoder may expect 3D video contents with more than two views.

In MVC, inter-view prediction is allowed among pictures in the same access unit (i.e., with the same time instance). When coding a picture in one of the non-base views, a picture may be added into a reference picture list if it is in a different view, but within the same time instance. An inter-view reference picture can be put in any position of a reference picture list, just like any inter prediction reference picture. As shown in FIG. 3, a view component can use the view components in other views for reference. In MVC, inter-view prediction is realized as if the view component in another view was an inter-prediction reference.

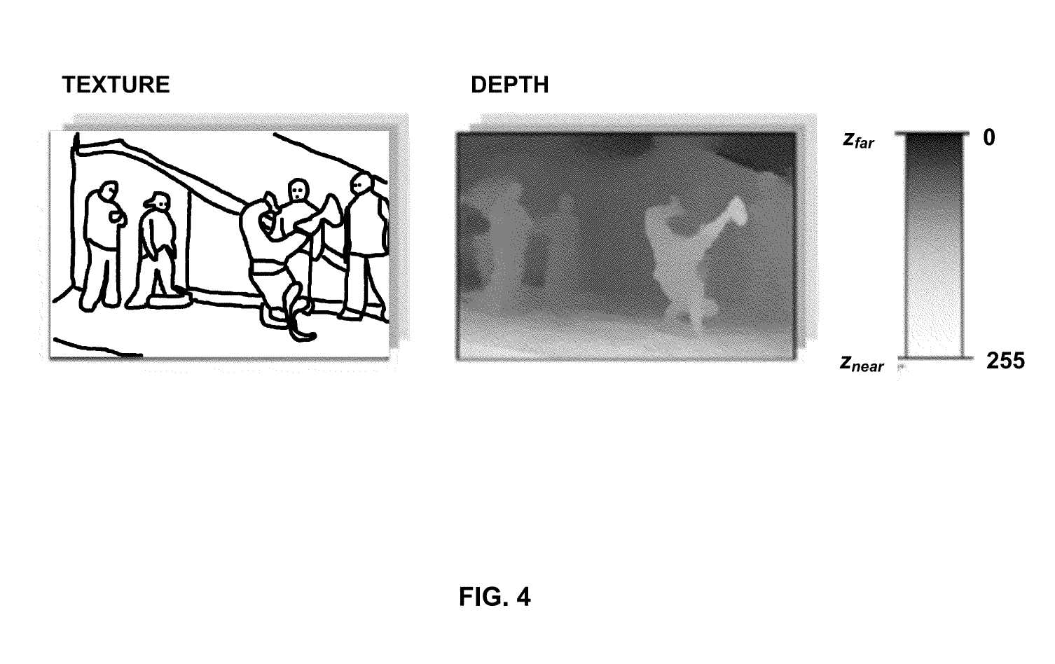

Another type of multiview video coding format introduces the use of depth values (e.g., as in 3D-HEVC). For the multiview-video-plus-depth (MVD) data format, which is a popular format for 3D television and free viewpoint videos, texture images and depth maps can be independently coded with multiview texture pictures. FIG. 4 illustrates the MVD data format with a texture image and the texture image's associated per-sample depth map. The depth range may be restricted to be in the range of minimum zₙₑₐᵣ and maximum z_{far} distance from the camera for the corresponding 3D points.

Camera parameters and depth range values may be helpful for processing decoded view components prior to rendering the decoded view components on a 3D display. Therefore, a special supplemental enhancement information (SEI) message is defined for the current version of H.264/MVC, e.g., multiview acquisition information SEI, which includes information that specifies various parameters of the acquisition environment. However, there are no syntaxes specified in H.264/MVC for indicating the depth range related information.

3D video (e.g., as specified by the emerging 3D-HEVC standard) may be represented using the Multiview Video plus Depth (MVD) format, in which a small number of captured texture images of various views (which may correspond to individual horizontal camera positions), as well as associated depth maps, may be coded and the resulting bitstream packets may be multiplexed into a 3D video bitstream.

Some techniques of a 3DV (e.g., 3D-HEVC) video coding system will now be discussed. In particular, techniques concerning view synthesis optimization (VSO) will be discussed. VSO is a coding tool using a rate-distortion optimization algorithm that attempts to improve the quality of reconstructed/decoded depth views. In addition to comparing the distortion between original and reconstructed depth views, VSO techniques may also take into consideration synthesized views created from both original and reconstructed depth views.

In a 3DV system, depth views are encoded together with texture views. At a video decoder (e.g., video decoder 30) additional synthesized views may be generated from the decoded depth view and the decoded texture view. Synthesized views are additional texture views that are generated from the decoded depth and texture views to provide for additional texture views at additional camera angles (e.g., for auto-stereoscopic displays). That is, synthesized views are pictures that are not decoded directly from an encoded video bitstream. Rather, synthesized views are generated from a decoded texture view and an associated depth view. Typically, the synthesized views are created using 3D warping techniques. In certain 3DV encoders, the ultimate goal of depth coding is not to improve the PSNR of the depth images themselves, but to improve the quality of the synthesized views created from the depth and texture views.

In some proposals for 3D-HEVC, VSO is implemented at the encoder (e.g., video encoder 20), when encoding each prediction unit of a depth picture. During the mode decision, the rate-distortion cost of each prediction mode (e.g., inter-prediction or intra-prediction) is calculated not only from the distortion between the reconstructed pixels of the block and the original pixel, but also from the distortion evaluated at the synthesized views. That is, a synthesized view distortion change (SVDC) is generated by comparing pixels synthesized by utilizing the reconstructed depth block and the pixels synthesized by utilizing the original depth block. The rate-distortion (RD) cost J is calculated with the following equation: J=(i_{DWeight}×D_{depth}+i_{VSOWeight}×SVDC)/(i_{DWeight}+i_{VSOWeight})+λ×R, where i_{DWeight} and i_{VSOWeight} are weighting factors. Note that R is the rate estimated at the encoder to encode the current depth block, lamda (λ) is the rate distortion parameter that is used in a typical RD Optimization (RDO) model (similar as in H.264/AVC or HEVC encoders) and D_{depth} is the distortion of the current depth block (e.g., sum of the square error of all pixels of the block). SVDC is defined as distortion difference (ΔD) between two synthesized textures s′_{T} and \tilde{s}_{T}, where

ΔD=\tilde{D}−D=Σ_{(x,y)∈I}[\tilde{s}_{T}(x,y)−s′_{T,Ref}(x,y)]²−Σ_{(x,y)∈I}[s′_{T}(x,y)−s′_{T,Ref}(x,y)]² (1)

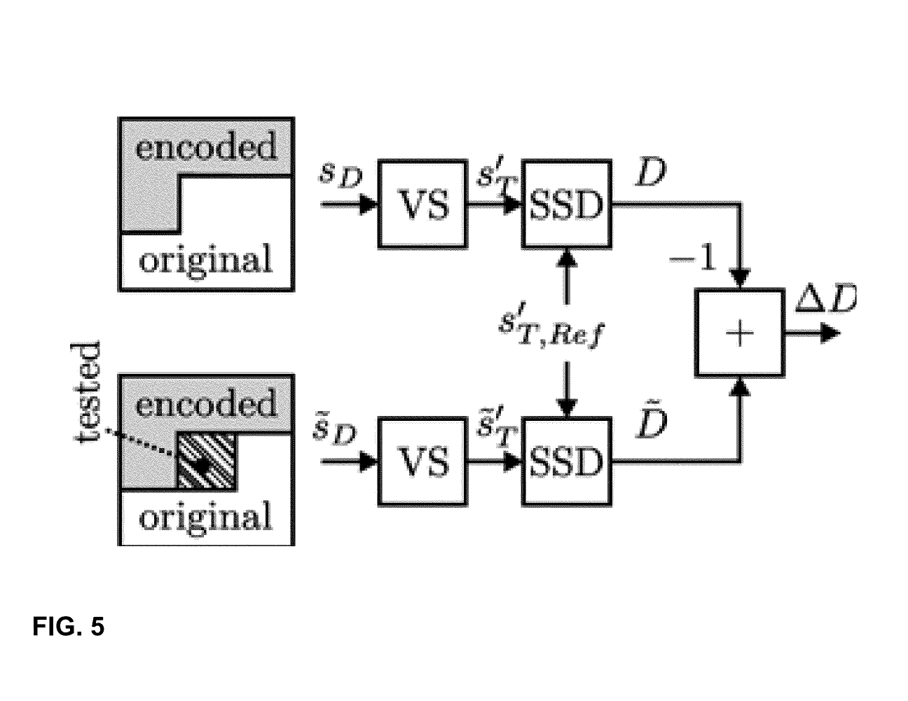

s′_{T,Ref} denotes a reference texture rendered from original texture and depth data. I represents the set of all samples in the synthesized view. To illustrate how the textures s′_{T} and \tilde{s}′_{T} are obtained, the SVDC definition from Equation (1) is also depicted in FIG. 5. s′_{T} denotes a texture rendered from a depth map s_{D} consisting of encoded depth data in already encoded blocks and original depth data in the other blocks. The current block B, for which the distortion is to be computed, contains original depth data as well. For the synthesis of the texture \tilde{s}′_{T}, a depth map \tilde{s}_{D} is used that differs from the depth map s_{D} in that it contains the distorted depth data for the current block B. In FIG. 5, the SVDC related to the distorted depth data of block B is depicted by the hatched area in the bottom branch. VS denotes the view synthesis step (i.e., the creation of an additional view from a texture view and a depth view) and SSD stands for a computation of the sum of squared differences.

Loop filtering processes in HEVC will now be discussed. In HEVC, sample adaptive offset (SAO) loop filtering has been introduced. SAO filtering involves classifying reconstructed/decoded pixels into different categories and then reducing the distortion of the reconstructed/decoded pixels by adding an offset based on each category of pixels. There are two major categories classified in SAO filtering, namely band offset and edge offset. Typically, SAO is applied after de-blocking filtering.

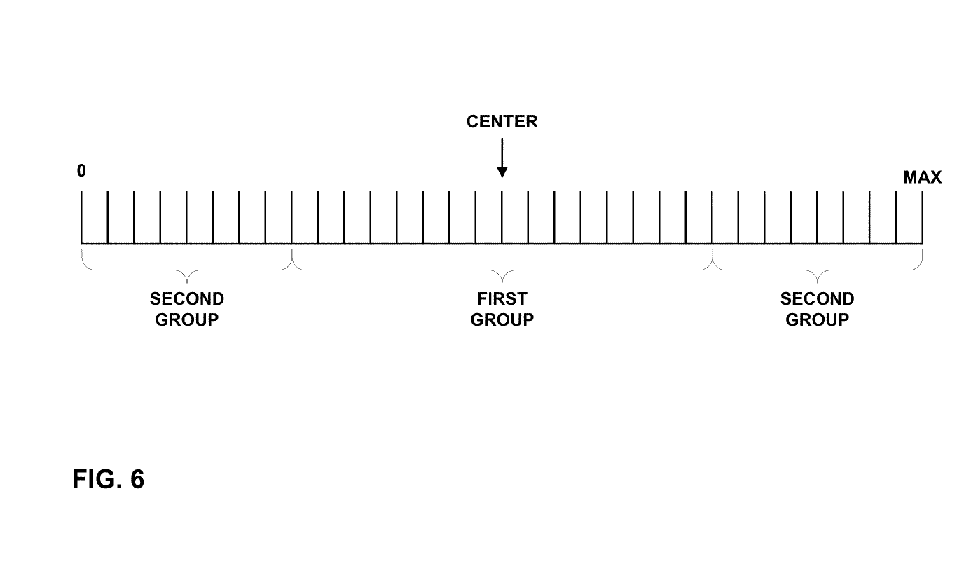

In band offset SAO filtering, the pixels are classified into multiple bands, where each band contains pixels of the same intensity level. In HEVC, the full sample range is uniformly divided into 32 bands. For example, for 8-bit pixels, the sample values from 8 k to 8 k+7 belong to the band k, where k ranges from 0 through 31, inclusive. FIG. 6 is a conceptual diagram showing an example band classification based offset type including a central band and a side band. As shown in FIG. 6 each of pixel intensities 0 to MAX may be categorized into one of 32 bands. In one example, pixels may have 8-bit intensity values and MAX may equal 255. In the example of FIG. 6, the 16 bands in the center are classified into a first group and the remaining side bands are classified into a second group.

In band offset mode, an offset value is added to all the samples in the same band. These offset values are calculated as an average difference between the original and reconstructed samples and are signaled to the decoder. In particular, only the four consecutive offset values along the starting band position are signaled. This choice is mainly motivated due to the fact that the intensity values in the given coded tree block (CTB) are highly similar with high probability that tends to be concentrated in few bands. Also, this design choice of transmitting only the four band offsets is unified with the number of signaled edge offsets.

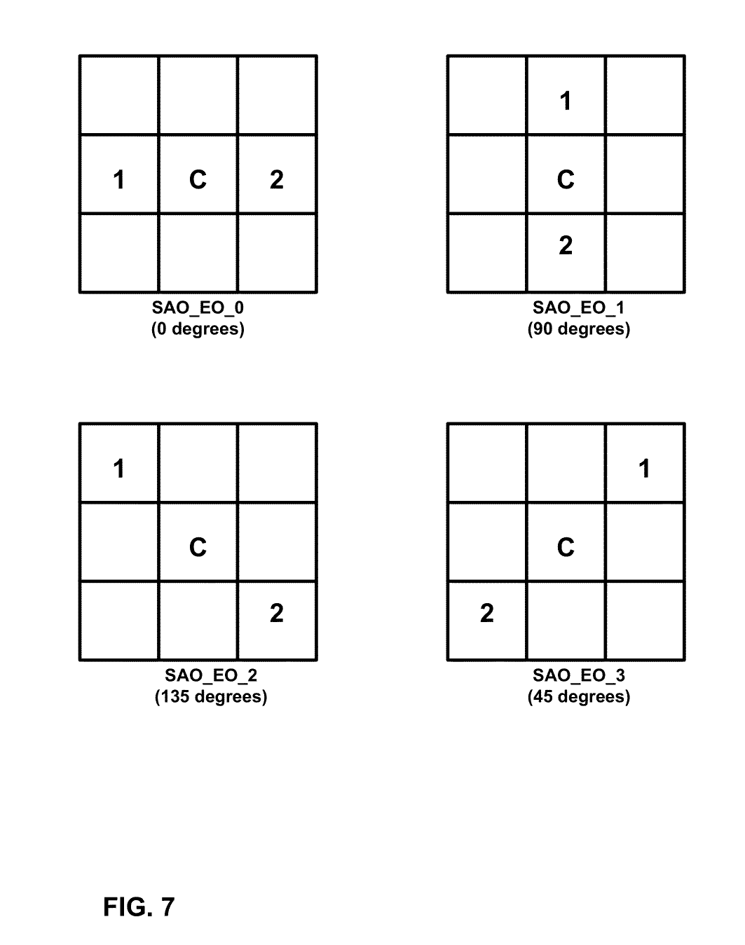

In edge offset mode of SAO, the pixels are classified into multiple categories by comparing each pixel with its two neighboring pixels. As shown in FIG. 7, edge offset uses four 1D patterns for the sample classification. For a given edge classification shown in FIG. 7, an edge type for the current pixel is calculated by comparing the value of the current pixel (C) to the values of neighboring pixels (e.g., pixel 1 and pixel 2). In some examples, pixel values may be an 8-bit string including 256 possible values or a 10-bit string including 1024 possible values. For SAO edge offset mode 0 (SAO_EO_{—}0), the current pixel is compared to the left and right neighbor pixels. For SAO edge offset mode 1 (SAO_EO_{—}1), the current pixel is compared to the top and bottom neighbor pixels. For SAO edge offset mode 2 (SAO_EO_{—}2), the current pixel is compared to the upper left and bottom right neighbor pixels. For SAO edge offset mode 3 (SAO_EO_{—}3), the current pixel is compared to the bottom left and upper right neighbor pixels.

For a given edge classification, the samples in the CTB can be classified into one of the five categories (see Table 1 below) by comparing the current pixel ‘C’ with its two neighboring samples. Note that the classification is done for each pixel based on the decoded samples so that additional signaling required to transmit the category type is avoided.

TABLE 1
Sample classification rules for the edge offset

| Category | Condition |
|---|---|
| 1 | c is smaller than 2 neighboring pixels |
| 2 | c is smaller than 1 neighbor and equal to another neighbor |
| 3 | c is larger than 1 neighbor and equal to another neighbor |
| 4 | c is larger than 2 neighbors |
| 0 | None of the above |

Categories 1 and 4 represent the local peak and local valley, respectively, and categories 2 and 3 represent concave and convex corners. The offset values are always positive for categories 1 and 2, and negative for categories 3 and 4, in order to ensure a smoothing effect. Therefore, in some examples, only the absolute values of the offset values are signaled to the decoder and the sign of the offset values can be easily determined at the decoder depending on the category of each pixel.

Among the four patterns, for each CTB, the encoder selects only one pattern for the pixel classification and the corresponding four (absolute) offset values are signaled to the decoder. The “best” pattern is usually selected at the encoder based on a rate-distortion optimization.

The signaling mechanism for SAO will now be discussed. In the sequence parameter set (SPS), one syntax element (e.g., the sample_adaptive_offset_enabled_flag) is used to indicate whether SAO is enabled in the current video sequence. In the slice header, two syntax elements (e.g., the slice_sao_luma_flag and the slice_sao_chroma_flag) are used to indicate whether SAO is enabled for luma and chroma, respectively, in the current slice.

For each coding tree unit (CTU), the SAO parameters can be inherited from a left neighboring block by setting the flag sao_merge_left_flag to true (e.g., setting the sao_merge_left_flag to a value of 1), or can be inherited from an above neighboring block by setting the flag sao_merge_above_flag to true (e.g., setting the sao_merge_above_flag to a value of 1). When both the flags, sao_merge_left_flag and sao_merge_above_flag, are set to false (e.g., flags respectively set to a value of 0), new SAO parameters for the current CTU are signaled as described below.

For each color component (e.g., Cb and Cr), the SAO type for the luma components and the chroma components are signaled by the sao_type_idx_luma syntax element and the sao_type_idx_chroma syntax element, respectively. In one example, the sao_type_idx_luma sytanx element with a value of two indicates edge offset, the sao_type_idx_luma sytax element with a value of one indicates band offset, and the sao_type_idx_luma syntax element with a value of 0 indicates that SAO is not applied. Note that the Cb and Cr components share the same SAO type and the edge offset class type. If band offset is selected, the starting band position is signaled in the sao_band_position syntax element along with the offset values sao_offset_abs and the corresponding sign syntax element (sao_offset_sign). Otherwise, if edge offset is selected, one of the four classes is signaled in the sao_eo_class syntax element along with the absolute offset values of the offsets (sao_offset_abs).

Example operations of a depth lookup table (DLT) in 3D-HEVC will now be discussed. The DLT is an optional coding tool. In the previous proposals for the HTM, a video encoder may not use DLT if more than half the values from 0 to MAX_DEPTH_VALUE (e.g., 255 for 8-bit depth samples) appear in the original depth map. Otherwise, a DLT will be coded in a parameter set (e.g., one or more of a sequence parameter set and/or a video parameter set).

In order to encode the DLT, the number of valid depth values is first encoded with an exponential Golomb (Exp-Golomb) code. Then each valid depth value is also coded with an Exp-Golomb code. The related syntax elements and semantics for signaling DLT are defined below in the video parameter set extension syntax table.

At video encoder 20, the Residual index iᵣₑₛᵢ to be coded into the bitstream, is calculated by the equation:

iᵣₑₛᵢ=DepthValue2Idx(d_{orig})−DepthValue2Idx(d_{pred})

, where d_{orig} denotes the original depth value, d_{pred} denotes the predicted depth value, and DepthValue2Idx(.) denotes the index to the lookup table (i.e., the DLT). At video encoder 20 an video decoder 30, the reconstructed/decoded depth value is derived by the equation:

d_{rec}=Idx2DepthValue(DepthValue2Idx(d_{pred})+iᵣₑₛᵢ)

, where DepthValue2Idx(.) denotes the index to the lookup table (i.e., the DLT).

The syntax for the DLT is shown in Table 2 below:

TABLE 2
Video parameter set extension syntax table

De-
scriptor

vps_extension( ) {
...

for( i = 0; i<= vps_max_layers_minus1; i++ ) {

if ( (i ! = 0) && !( i % 2 ) ) {

| | |
|---|---|
| multi_view_mv_pred_flag[ i ] | u(1) |
| multi_view_residual_pred_flag[ i ] | u(1) |

}
if ( i % 2 ) {

| | |
|---|---|
| enable_dmm_flag[ i ] | u(1) |
| use_mvi_flag[ i ] | u(1) |
| lim_qt_pred_flag[ i ] | u(1) |
| dlt_flag[ i ] | u(1) |
| if( dlt_flag[ i ] ) { | |

| | |
|---|---|
| num_depth_values_in_dlt[ i ] | ue(v) |
| for ( j = 0; | |
| j <num_depth_values_in_dlt[ i ] ; | |
| j++) { | |

| | |
|---|---|
| dlt_depth_value[ i ][ j ] | ue(v) |

}

}

}

}

}

The following semantics apply. The syntax element dlt_flag[i] with a value equal to 1 specifies that the depth lookup table is used and that residual values for simplified depth coded coding units are to be interpreted as indices of the depth lookup table for depth view components with the value of syntax element layer_id equal to i. The syntax element dlt_flag[i] with a value equal to 0 specifies that depth lookup table is not used and residual values for simplified depth coded coding units are not to be interpreted as indices for depth view components with the value of syntax element layer_id equal to i. When a value for the syntax element dlt_flag[i] is not present, the value for the syntax element dlt_flag[i] shall be inferred to be equal to 0.

The value of syntax element num_depth_values_in_dlt[i] specifies the number of different depth values and the number of elements in the depth lookup table for depth view components of the current layer with the value of syntax element layer_id equal to i.

The value of syntax element dlt_depth_value[i][j] specifies the j-th entry in the depth lookup table for depth view components with a value of syntax element layer_id equal to i.

In some proposals for HEVC, loop filtering, including SAO and de-blocking, are not enabled for depth maps. This is because current loop filtering techniques are not able to compensate the distortion introduced when encoding depth maps, mainly due to the different characteristics of depth pixels compared to texture pixels. Instead, a technique called adaptive depth edge filtering (ADEF) is sometimes used.

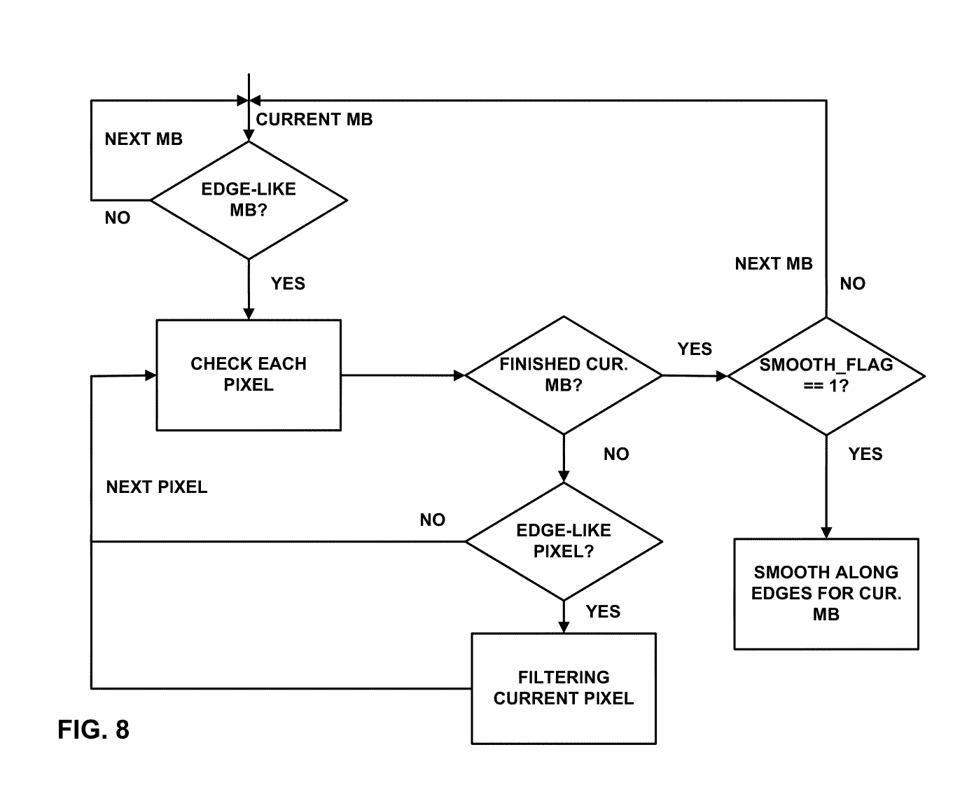

ADEF is a technique whereby edges in depth maps are preserved. A flowchart showing an example ADEF process is shown in FIG. 8. The example of FIG. 8 will be described with reference to macroblock, as used in H.264/AVC, but may be applied depth blocks in any 3D video coding process, including 3D-HEVC. As shown in FIG. 8, for each macroblock MB (or more generically, a block of depth data), the smoothness of the block is first checked by calculating the average absolute deviation with the following equation,

$${V}_{1} = \frac{1}{N} {\sum }_{( i , j ) ∈ MB} \vert I ( i , j ) - {\overline{I}}_{MB} \vert$$

,where N is the total number of pixels in a macroblock (N=256 in this implementation), I(i,j) is the intensity value of depth pixel (i,j) and

$${\overline{I}}_{MB} = \frac{1}{N} {\sum }_{( i , j ) ∈ MB} I ( i , j )$$

is the intensity mean of the macroblock.

If the average absolute deviation value V₁ is large enough (e.g., larger than a threshold; V₁>T₁), the current macroblock might contain some edges and is classified as edge-like macroblock; otherwise, the macroblock is determined to be probably very smooth, and depth edge filtering may be skipped for the whole macroblock. In one example, the threshold value T₁ is set as:

$${T}_{1} = {2}^{- \frac{QP}{6} + 1} + 1$$

, where QP is the quantization parameter of the current slice.

If current macroblock is an edge-like macroblock, for each pixel in the macroblock, the difference of the maximum and minimum depth intensity value within a neighborhood is calculated with the following equation,

V₂=|max(I_{W}(i,j))−min(I_{W}(i,j))|

, where I_{W}(i,j) represents intensity values of pixel (i,j) in an n by n window (5×5 used in our implementation) centered at the current pixel(i, j). If V₂ is large enough (e.g., larger than a threshold; V₂>T₂), the current pixel is classified as an edge-like pixel and will be filtered. In this implementation, T₂ is set to 10. Otherwise, the current pixel is classified as a smooth pixel in a homogeneous depth region, and will not be filtered.

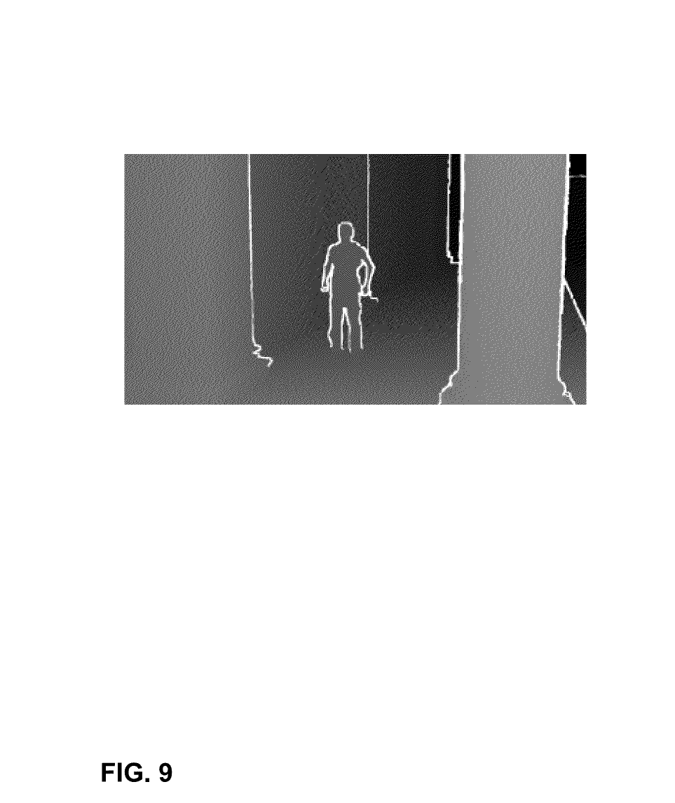

Therefore, by using the two deviation values V₁ and V₂, smooth macroblocks may be bypassed (i.e., not filtered). For a macroblock that might have edges (e.g., as indicated by deviation value V₁), any pixels designated as smooth pixels (e.g., as indicated by deviation value V₂) may also be bypassed (i.e., not filtered). FIG. 9 shows an example of the pixel locations that are detected as edge-like pixels and filtered in example ADEF algorithms. Only the pixels marked with white color are filtered. Thus, only a small portion of the pixels in the whole frame is processed, so that the increased complexity due to the proposed ADEF depth filtering is kept small.

For ADEF, the edge-like pixels in a current macroblock are filtered as follows:
1. Within an n by n window W (e.g., 5×5) centered at the current pixel, calculate the mean value

$${\overline{I}}_{W} = \frac{1}{{n}^{2}} {\sum }_{( i , j ) ∈ W} I ( i , j ) .$$

2. Classify each pixel within the window W into two classes,

C₁={I(i,j)}_{I(i,j)<i}_{_{W}},

C₂={I(i,j)}_{I(i,j)≧Ī}_{_{W}},
according to their distance to the mean value I.
3. Calculate mean value of each class:

$${\overline{I}}_{{C}_{1}} = \frac{1}{{N}_{1}} {\sum }_{( i , j ) ∈ {C}_{1}} I ( i , j )$$

$${\overline{I}}_{{C}_{2}} = \frac{1}{{N}_{2}} {\sum }_{( i , j ) ∈ {C}_{2}} I ( i , j )$$

where N₁ is the total number of pixels belong to class C₁ and N₂ is the total number of pixels belong to class C₂(N₁+N₂=n²).
4. For each class, find the pixel with the minimum distance to the mean value in that class:

P₁=argmin_{(i,j)∈C}_{₁}|Ī_{C}_{₁}−I(i,j)|

P₂=argmin_{(i,j)∈C}_{₂}|Ī_{C}_{₂}−I(i,j)|
The two intensity values I(P₁) and I(P₂) are regarded as the representing values of the two classes.
5. Set the filtered value for current pixel P as one of the representing values by

$$I ( P ) = \{ \begin{matrix}I ( {P}_{1} ) & if \vert ( P ) - I ( {P}_{1} ) \vert < \vert I ( P ) - I ( {P}_{2} ) \vert \\ I ( {P}_{2} ) & otherwise\end{matrix} ,$$

i.e., the filtered value is the representing value of the class that has larger intensity similarity to the current pixel I(P).

Current proposals for 3D-HEVC do not include any techniques or mechanisms to enhance depth images for the purpose of generating better quality synthesized views (i.e., synthesized views with lower distortion relative to current view synthesis techniques). As such, the following drawbacks are present in 3D-HEVC coding. Due to the VSO process, reconstructed depth images might include numerous block artifacts. Block artifacts are typically removed by detecting the edges of a picture and applying filtering at the edges. However, the edge information of the depth images cannot be precisely detected and filtered at the decoder. Even when the depth images are enhanced to be closer to the original depth maps (e.g., using ADEF techniques described above), such enhancement might lead to worse performance of view synthesis prediction. Additionally, the edge pixels of a depth block may need to be corrected (e.g., filtered). However, traditional block-level residual coding is not efficient in representing such distortion information. That is, when using block-level residual coding on depth blocks, distortion in the depth blocks is difficult to detect and correct, since detecting edges in a depth block is difficult.

In view of these drawbacks, this disclosure presents techniques for performing an in-loop filtering processes on depth maps for 3D video coding processing, including 3D-HEVC. In one or more examples, this disclosure proposes techniques for sample edge offset (SEO) in-loop filtering for a 3DV video coding system (e.g., 3D-HEVC) to improve the quality of depth maps, thus improving the quality of synthesized views (e.g., generated through VSO and VSP).

One or more examples of this disclosure includes techniques where edges of a depth block are detected in order to apply SEO filtering to detected edge pixels in the depth block. Techniques for SEO filtering will be described in more detail below. In a particular example of the disclosure, video encoder 20 and/or video decoder 30 may be configured to detect edges in a depth block by first detecting edges in a texture block, and correlating the locations of the detected edges in the texture block to locations in the depth block. That is, an edge detection process is performed on pixels in a texture block, and the locations of edges in the texture are correlated with locations in the depth block. The correlated locations in the depth block are then designated as edges of the depth block.

Pixels in the depth block that are designated as edge pixels are processed with an edge enhancement processes (e.g., SEO filtering), while other pixels of the depth block are not changed. As will be explained in more detail below, edge pixels may be classified into different categories, each of which is associated with one offset value. The offset values (e.g., SEO offset values) for each category of depth block edge pixel may be signaled by video encoder 20 and received (or obtained) by the video decoder 30. After decoding the SEO offset value, video decoder 30 may be configured to apply the signaled offset to the value of the associated depth edge pixel.

For example, video decoder 30 may determine the category of the edge pixels, and in some examples, determine the category of the edge pixels without needing additional information from video encoder 20. Video decoder 30 may determine which of the signaled offset values to apply based on the determined category of the edge pixels, and then apply the determined offset values.

VSO may be applied together with the SEO techniques of this disclosure. For example, when SEO is applied for a depth block, not only is the distortion of the current depth block improved, but also the quality of the synthesized views. In one example, the VSO and SEO techniques of this disclosure may be performed in video encoder 20 and/or video decoder 30 after the reconstruction process for a whole depth image. In another example, the VSO and SEO techniques of this disclosure may be performed in video encoder 20 and/or video decoder 30 in the reconstruction loop at a block level after each CU is encoded/decoded. The SEO techniques of this disclosure may also be applied with other processing methods (e.g., ADEF) to adaptively apply a specific combination of a method on a depth block or depth picture level.

The next section of the disclosure describes example depth block edge detection techniques. In one example, the edge detection techniques of this disclosure may be performed on the pixels of a texture block that correspond to a depth block. This is because edges are generally easier to detect in texture blocks than in depth blocks. Furthermore, edges detected in texture blocks generally correspond highly with edges in co-located locations in depth blocks. When an edge is detected in a texture block, the corresponding pixels in the depth block are designated as edge pixels. In another example, the edge detection techniques of this disclosure may be performed directly on the reconstructed depth blocks. That is, edges may be detected in the depth block by applying edge detection techniques to the depth pixels themselves. In other examples, edges in a depth block may be detected using edge detection techniques that are applied to both depth pixels in the depth and texture pixels in a texture block corresponding to the depth block.

In one example of the disclosure, a Sobel operator is used to detect only the horizontal edge of each pixel of the depth block. Video encoder 20 and/or video encoder 20 may mark texture pixels within a given range (e.g., location within the texture block) for edge detection processing. In one example, video encoder 20 and/or video decoder 30 may be configured to use a horizontal derivative approximation to detect edges in a texture block. As one example, the horizontal derivation approximation may utilize matrix of

$$[ \begin{matrix}- 1 & 0 & 1 \\ - 2 & 0 & 2 \\ - 1 & 0 & 1\end{matrix} ]$$

that is applied to pixels in the texture block. This operation can be more simply represented as D[y−1][x+1]+2*D[y][x+1]+D[y+1][x+1]−D[y−1][x−1]−2*D[y][x−1]−D[y+1][x−1]. If the value obtained after the Sobel operator is applied (i.e., applied to a pixel in the texture block) is larger than some predetermined threshold (e.g., 4 or 10), video encoder 20 and/or video decoder 30 may designate the pixel as an edge pixel. For any pixels designated as edge pixels in the texture block, video encoder 20 and/or video decoder 30 may then find (e.g., identify) co-located depth pixels in a depth block corresponding to the texture block, and designate the co-located pixels in the depth block as depth edge pixels. It should be understood that the Sobel operator is only one example of an operator to detect edges that may be used. Other operators may also be used.

The above edge detection example describes the detection of horizontal edges. In other examples vertical edges may be detected. In still other examples, both horizontal and vertical edges may be detected to determine if a pixel is an edge pixel. In further examples, edges at a plurality of different angles may be detected.

Pixels in the reconstructed/decoded depth block that are detected/designated as edge pixels may then be processed with an edge enhancement decoding process (e.g., SEO filtering), while other pixels are not changed. In accordance with one or more examples of this disclosure, the edge enhancement process may include a SEO filtering process whereby offset values are added to the edge pixels in the reconstructed/decoded depth blocks.

In one example technique for SEO filtering of this disclosure, video encoder 20 and/or video decoder 30 is configured to add an offset value to each designated edge pixel in the depth block. In one example, each edge pixel may be classified into one of multiple categories. For each category of edge pixel, an offset is signaled/received.

In one example, at video decoder 30, the average value of a particular category of depth edge pixels is initially calculated. The index to the DLT corresponding to this average value is then identified. Video decoder 30 then identifies the difference between the DLT index to the average value of the corresponding original depth block and the average value of the reconstructed depth block. Therefore, the final index to the DLT of this particular category of depth edge pixels can be derived. Before coding, the offset is calculated as Offset=DepthValue2Idx(d_{AvgOrg})−DepthValue2Idx (d_{AvgRec}). Then, the reconstructed depth value is d′_{Rec}=Idx2DepthValue(Idx2DepthValue (d_{AvgRec})+Offset).

In one example of the disclosure, the categorization of edge pixels at video decoder 30 is performed as follows. In a first example, two categories of depth edge pixels are utilized. Initially, the average value of all masked pixels (i.e., the depth pixels from which depth edge pixels were identified) is calculated. Based on this average value, the designated depth edge pixels are classified into two categories. Video decoder 30 designates depth edge pixels that have values smaller than the average value of all masked pixels in a first category, and designates depth edge pixels that have values greater than or equal to the average value of all masked pixels in a second category.

In another example of the disclosure, video decoder 30 classifies depth edge pixels into four categories in a pyramid manner. The first and second categories are determined using the same method described above (i.e., classifying depth edge pixels based on whether their respective values are above or below an average value of all masked pixels). Once divided into the first and second categories, video decoder 30 may divide each of the depth edge pixels in the first and second categories into two further categories. That is, for the first category, depth edge pixels with a value greater than or equal to the average all depth pixels within the first category are designated into one category, and depth edge pixels with a value less than the average of all depth pixels within the first category are designated into another category. This process is repeated for the initial second category.

In other examples, video decoder 30 may use other clustering methods to separate the depth edge pixels into one, two, or more categories. In this example, the number of categories of depth edge pixels maybe signaled to avoid the parsing dependency. In another example, the categorization, or at least a first step of the categorization, is based on the trend of the horizontal derivative approximation. For example, one category contains depth edge pixels with values (from the Sobel operator) larger than 0, and the other category contains pixels with values smaller than 0.

In another example, this disclosure further proposes that the above discussed techniques for edge detection and SEO filtering may comprise just one of the multiple processing modes. The edge detection and SEO filtering techniques of this disclosure may be used together with other processing modes, e.g., ADEF mode. The processing mode may be signaled at PU level, CU level slice level, or one or more of the picture parameter set (PPS), sequence parameter set (SPS) and video parameter set (VPS).

The next section will describe the operation of video encoder 20 when performing the SEO techniques of this disclosure. In one example, after the reconstruction process for the whole depth picture is performed, video encoder 20 performs the following process for each coding tree block (CTB). First, video encoder 20 determines the current rate-distortion value Jₒ for the current CTB. Next, edge detection is performed, as described above, on the reconstructed depth block. Again, video encoder 20 may be configured to perform the edge detection process on a texture block, and then, for any edge pixels detected in the texture block, designate depth pixels, which are co-located with the detected edge pixels in the texture block, as depth edge pixels.

Next, video encoder 20 may be configured to classify designated depth edge pixels into one or more categories, as described above. Video encoder 20 may be configured to generate offset values for each of the categories of depth edge pixels. Video encoder 20 may generate an offset value based on the sample values of the edge pixels in reconstructed depth picture and the values of edge pixels in the original depth picture. For each category, the average of original depth value d_{AvgOrg} and reconstructed depth value d_{AvgRec} are calculated and mapped to the index in the DLT, respectively. The offset value is the difference between these two indexes.

Video encoder 20 may then apply the offset value(s) to edge pixels of the reconstructed depth block (e.g., add the offset value(s) to the designated depth edge pixels). Video encoder 20 may then employ VSO techniques for any synthesized views based on the depth block filtered with the above-described SEO techniques to obtain the rate-distortion value Jₑ. If the rate-distortion value Jₑ is smaller than Jₒ, a syntax element or flag (e.g., seo_flag) is set to 1, indicating that SEO filtering is to be used at video decoder 30. If the rate-distortion value Jₑ is larger or equal to Jₒ, a syntax, seo_flag is set to 0, indicating that SEO filtering is not to be used at video decoder 30.

If, for all CTBs, the seo_flag is equal to 0, a slice level flag (e.g., seo_slice_flag) may be set to 0 indicating that video decoder 30 does not need to use SEO for any depth blocks in the slice. Otherwise, seo_slice_flag is set to 1, indicating that video decoder 30 may need to apply SEO for at least one depth block in the slice. If the seo_slice_flag is equal to 1, video encoder 20 may generate and signal the seo_flag for each CTB. Again, the seo_flag equal to 0 indicates SEO is not used for the current CTB, and the seo_flag equal to 1 indicates SEO is used for the current CTB and the offsets for different categories are further signaled.

In another example, the SEO parameters (i.e., flags and offset values) may be generated and signaled for each N×N block, wherein N can be 8, 16, 32, or 64 satisfying N×N is not bigger than the CTU size. In another example, the size of the process unit (e.g., the N×N block) may be signaled in the slice header, picture parameter set, sequence parameter set or video parameter set. In another example, the SEO parameters may be signaled for each coding unit.

In another example, signaling/parsing the SEO parameters may not need to be done at the picture level as described above. In this example, after video encoder 20 makes the mode decision of each CU, video encoder 20 may make the determination as to whether SEO is to be performed for that CU by calculating the rate-distortion values discussed above on a CU level. In another example, for each mode (e.g., intra or inter), the rate-distortion values used to determine whether or not to use SEO may be calculated for each mode.

In another example, video encoder 20 is configured to calculate the offset value(s) not to provide the smallest distortion between the enhanced depth values and the original depth values, but to provide the smallest distortion for synthesized views. For each category of depth edge pixel, a maximum offset is predetermined. Video encoder 20 may perform rate-distortion calculation in a loop from 0 to this maximum offset value to find the offset value with minimum rate-distortion cost. This is based on the fact that different depth values may correspond to the same disparity. In one example, the maximum offset value may be defined as the DLT difference of d_{AvgOrg} and d_{AvgRec}. In another example, the maximum offset value may be defined as the difference between the d_{OrgMax} and d_{RecMin}, or value generated with another method.

The next section will discuss example techniques for generating and signaling SEO parameters for 3D-HEVC. The syntax element seo flag may be predicted from the same flag in the neighboring CTBs. One example technique for predicting the value of the seo_flag is to select context model based on the neighboring CTBs. For example, ctxIdx=seo_flagᵤₚ+seo_flag_{left}. In another example, the seo_flag and modes can be merged with up and left CTBs. The offset values can be coded in the form of a sign bit and absolute value. The absolute value may be coded with a unary code. In another example, the absolute value may be coded with exponential Golomb codes.

The next section shows example syntax elements and corresponding semantics for signaling SEO parameters for in-loop filtering of depth maps according to the techniques of this disclosure.

TABLE 3
Slice Segment Layer RBSP Syntax

De-
scriptor

slice_segment_layer_rbsp( ) {

slice_segment_header( )
slice_segment_data( )
if (depthFlag)

seo_parameter( )

rbsp_slice_segment_trailing_bits( )

}

TABLE 4
SEO Parameter Syntax

De-
scriptor

seo_parameter( ) {

| | |
|---|---|
| slice_seo_flag | u(1) |
| if(frame_seo_flag){ | |

for( i=slice_segment_address;
i<CtbAddrInRsEnd; i++){

| | |
|---|---|
| lcu_seo_flag[ i ] | ae(1) |
| if( lcu_seo_flag[ i ]){ | |

| | |
|---|---|
| lcu_seo_mode[ i ] | ae(1) |
| if( lcu_seo_mode[ i ]= = 1) | |

for(j=0; j<4; j++){

| | |
|---|---|
| lcu_seo_offset[ i ][ j ] | ae(v) |
| if( lcu_seo_offset[ i ][j]!=0 ) | |

| | |
|---|---|
| lcu_seo_offset_sign[ i ][ j ] | ae(1) |

}

}

}

}

The SEO parameter semantics are as follows:
frame_seo_flag equal to 1 specifies sample edge offset is enabled for the current slice.
frame_seo_flag equal to 0 specifies that sample edge offset is disabled for the current frame.
lcu_seo_flag[i] equal to 1 specifies sample edge offset is enabled for the i-th LCU;
lcu_seo_flag equal to 0 specifies that sample edge offset is disabled for the i-th LCU.
lcu_seo_mode[i] specifies the sample edge offset mode of the current LCU.
lcu_seo_mode[i] equal to 1 indicates that the mode for i-th LCU is SEO mode.lcu_seo_mode equal to 0 indicates that the mode for the i-th LCU is ADEF mode.
lcu_seo_offset[i][j] specifies the absolute value of the offset.
lcu_seo_offset_sign[i ][j] specifies the sign of lcu_seo_offset[i][j] when is not equal to 0. If lcu_seo_offset[i][j] equal to 1, LCUSeoOffset[i][j] is set equal to −lcu_seo_offset[i][j]. if lcu_seo_offset[i][j] equal to 0, LCUSeoOffset[i][j] is set equal to lcu_seo_offset[i][j].
slice_segment_address and CtbAddrinRsEnd are the starting and ending LCU address of the current slice.
I another example, seo parameter syntax elements may be present for each coding tree block only.

TABLE 5
CTU Syntax

De-
scriptor

coding_tree_unit( ) {

xCtb = ( CtbAddrInRs % PicWidthInCtbsY ) <<
CtbLog2SizeY
yCtb = (CtbAddrInRs / PicWidthInCtbsY ) <<
CtbLog2SizeY
if( slice_sao_luma_flag || slice_sao_chroma_flag )

sao( xCtb >> CtbLog2SizeY, yCtb >>
CtbLog2SizeY )

else if ( depthFlag &&slice_seo_flag )

seo( xCtb >> CtbLog2SizeY, yCtb >>
CtbLog2SizeY)

coding_quadtree( xCtb, yCtb, CtbLog2SizeY, 0 )

}

Here, slice_seo_flag is present in the slice header.

TABLE 6
SEO Syntax

De-
scriptor

seo(rx, ry ) {

| | |
|---|---|
| lcu_seo_flag | ae(1) |
| if( lcu_seo_flag ){ | |

| | |
|---|---|
| lcu_seo_mode | ae(1) |
| if( lcu_seo_mode= = 1) | |

for(j=0; j<4; j++){

| | |
|---|---|
| lcu_seo_offset[ j ] | ae(v) |
| if( lcu_seo_offset[ j ]!=0 ) | |

| | |
|---|---|
| lcu_seo_offset_sign[ j ] | ae(1) |

}

}

}

The syntax elements for seo( ) have similar semantics as those in seo_parameters with the same name, but they are applicable only to the current CTB tree.

The following is an example SEO process as proposed for inclusion into the 3D-HEVC standard. Inputs of this process are the reconstructed picture sample arrays prior to sample edge offset recDepth. Outputs of this process are the modified reconstructeddepth sample arrays after sample adaptive offset seoDepth. This process is performed on a LCU basis after the completion of recontruction process for the decoded depth map. The sample values in the modified reconstructeddepth sample arrays after sample edge offset seoDepth are initially set equal to the sample values in the reconstructeddepth sample arrays prior to sample edge offset recDepth. For k-thLCU with location (xs, ys), where xs=0 . . . PicWidthInCtbsY−1 and ys=0 . . . PicHeightInCtbsY−1, when slice_frame_seo flag of the current picture is equal to 1, the coding tree block modification process as specified below is invoked.

The LCU (CTB) modification process will now be discussed. Inputs to this process are:
depth sample array recDepth,
corresponding texture luma sample array recTextureY,
a pair of variables (xs, ys) specifying the LCU location, where xs=(k % PicWidthInLcu)*MaxCUSize, ys=(k/PicWidthInWidth)*MaxCUSize,

Output of this process is a modified depth sample array seoDepth.

The variables xe and ye are set equal to min(MaxCUSize,FramePicWidthinPix−xs) and min(MaxCUSize,FramePicHeightinPix−ys), respectively.seoDepth[x][y] is set to recDepth, where x=xs . . . xe, y=ys . . . ye.

Depending on the value frame_seo_flag, lcu_seo_flag[k], lcu_seo_mode[k] and lcu_seo_offset_sign[k], the following applies:

If one or more of the following conditions are true, seoDepth[x][y ] is not modified.
frame_seo_flag is equal to 0.
lcu_seo_flag[i] is equal to 0.

Otherwise if lcu_seo_mode[i] is equal to 1, the following ordered steps apply:
The variable edgeFilPos[x][y] is derived as follows:
   Set edgeFilPos[x][y] to be 0. Calculte the range of process window, whose up-left position is (is, js) and down-right position is (ie,je).

is=xs==0? xs+1:xs

js=ys==0? ys+1:ys

ie=xe==FramePicWidthinPix? FramePicWidthinPix−1:xe

je=ye==FramePicHeightinPix? Frame PicHeightinPix−1:ye
For each pixel (i,j), calculate the horizontal edge strength EdgeStrength[i][j] detection on recTextureY[i][j], where m=is . . . ie and n=js . . . je.
EdgeStrength[i][j]

=recTexture_{Y}[j−1][i+1]+2*recTexture_{Y}[j][i+1]

+recTexture_{Y}[j+1][i+1]−recTexture_{Y}[j−1][i−1]−2

*recTexture_{Y}[j][i−1]−recTexture_{Y}[j+1][i−1]
If EdgeStrength[i][j] is larger than a Thres, set edgeFilPos[k][v] to be 1, where k=max(xs,i−2) . . . min(xe,i+2) and v=max(ys,j−2) . . . min(ye,j+2).
Classify the masked postion into four classes with edgeFilPos from 1˜4 in decending order of the average depth intensity
   For all position with edgeFilPos[x][y] not equal to 0, calculte the average value D_{avgrec} of recDepth.

$${D}_{avgrec} = \frac{1}{n} {\sum }_{edgeFilPos ( i , j ) != 0} recDepth ( i , j ) .$$

Where n the number of pixels with edge pixels.
If recDepth[x][y] is larger than D_{avgrec}, the corresponding edgeFilPos[x][y] is set to be 2.

$$edgeFilPos [ x ] [ y ] = \{ \begin{matrix}1 , & recDepth [ x ] [ y ] < {D}_{avgrec} \\ 2 , & recDepth [ x ] [ y ] \geq {D}_{avgrec}\end{matrix}$$

Further classify each of the two classes into two classes using the same method as decribled above.

$$edgeFilPos [ x ] [ y ] = \{ \begin{matrix}1 , & & recDepth [ x ] [ y ] < {D}_{savgrec} \\ 2 , & recDepth [ x ] [ y ] \geq {D}_{savgrec} , & recDepth [ x ] [ y ] < {D}_{avgrec} \\ 3 , & recDepth [ x ] [ y ] \geq {D}_{avgrec} , & recDepth [ x ] [ y ] < {D}_{bavgrec} \\ 4 , & & recDepth [ x ] [ y ] \geq {D}_{bavgrec}\end{matrix}$$

where D_{savgrec} and D_{bavgrec} are the average depth intensity of the two classes.
For each masked class, seoDepth is calculate as follows.

seoDepth[x][y]=Idx2DepthValue(Idx2DepthValue(recDepth[x][y])+Offset).
For other un-masked pixels, seoDepth[x][y] is equal to recDepth[x][y].
Otherwise(lcu_seo_mode[i] is equal to 0), the following ordered steps apply:
For each pixel(x,y), x=xs+2 . . . xe−2, y=ys+2 . . . ye−2.
Calculate the difference of the maximum and minimum depth intensity value within a neighborhood.

V₂=|max(recDepth[i][j])−min(recDepth[i][j])|
Where (i,j)is in a 5 by 5 window centered at the current pixel(x, y), that is i=x−2 . . . x+2 and j=y−2 . . . y+2.
If V₂ is larger than 10, the current pixel is regarded as an edge-like pixel and is going to be filtered in the next steps.
   Within an 5 by 5 window W centered at the current pixel, calculate the mean value

$${D}_{avgrec} = \frac{1}{{n}^{2}} {\sum }_{( i , j ) ∈ W} recDepth ( i , j ) .$$

Classify each pixel within the window W into two classes, according to their distance to the mean value D_{avgrec}.

C₁={recDepth(i,j)}_{recDepth(i,j)<D}_{avgrec}

C₂={recDepth(i,j)}_{recDepth(i,j)≧D}_{avgrec}
Calculate mean value of each class:

$${D}_{{C}_{1}} = \frac{1}{{N}_{1}} {\sum }_{( i , j ) ∈ {C}_{1}} recDepth ( i , j )$$

$${D}_{{C}_{2}} = \frac{1}{{N}_{2}} {\sum }_{( i , j ) ∈ {C}_{2}} recDepth ( i , j )$$

where N₁ is the total number of pixels belong to class C₁ and N₂ is the total number of pixels belong to class C₂(N₁+N₂=n²).
For each class, find the pixel with the minimum distance to the mean value in that class:

P₁=argmin_{(i,j)∈C}_{₁}|D_{C}_{₁}−recDepth(i,j)|

P₂=argmin_{(i,j)∈C}_{₂}|D_{C}_{₂}−recDepth(i,j)|
The two intensity values D(P₁) and D(P₂) are regarded as the representing values of the two classes.
Set the filtered value for current pixel P as one of the representing values by

$$seoDepth ( P ) = \{ \begin{matrix}D ( {P}_{1} ) & if \vert recDepth ( P ) - D ( {P}_{1} ) \vert < \vert recDepth ( P ) - D ( {P}_{2} ) \vert \\ D ( {P}_{2} ) & otherwise\end{matrix} ,$$

Otherwise, the current pixel is considered as a smooth pixel in a homogeneous depth region, and will not be filtered. seoDepth is copied from recDepth.

The following tables show the initialization values for context variables.

| | | initType | | |
|---|---|---|---|---|
| Syntax element | ctxIdxTable | 0 | 1 | 2 |
| lcu_seo_flag | Table H-xx | 0 | 1 | 2 |
| lcu_seo_mode | Table H- xx | 0 | 1 | 2 |
| lcu_seo_offset | Table H- xx | 0 . . . 3 | 4 . . . 7 | 8 . . . 11 |
| lcu_seo_offset_sign | Table H- xx | 0 | 1 | 2 |

| Initialization | lcu_seo_flag | | |
|---|---|---|---|
| variable | 0 | 1 | 2 |
| initValue | 154 | 154 | 154 |

| Initialization | lcu_seo_mode | | |
|---|---|---|---|
| variable | 0 | 1 | 2 |
| initValue | 154 | 154 | 154 |

| Initialization | lcu_seo_offset_sign | | |
|---|---|---|---|
| variable | 0 | 1 | 2 |
| initValue | 154 | 154 | 154 |

| Initialization variable | lcu_seo_offset | | | |
|---|---|---|---|---|
| | 0 | 1 | 2 | 3 |
| initValue | 154 | 154 | 154 | 154 |
| | 4 | 5 | 6 | 7 |
| initValue | 154 | 154 | 154 | 154 |
| | 8 | 9 | 10 | 11 |
| initValue | 154 | 154 | 154 | 154 |

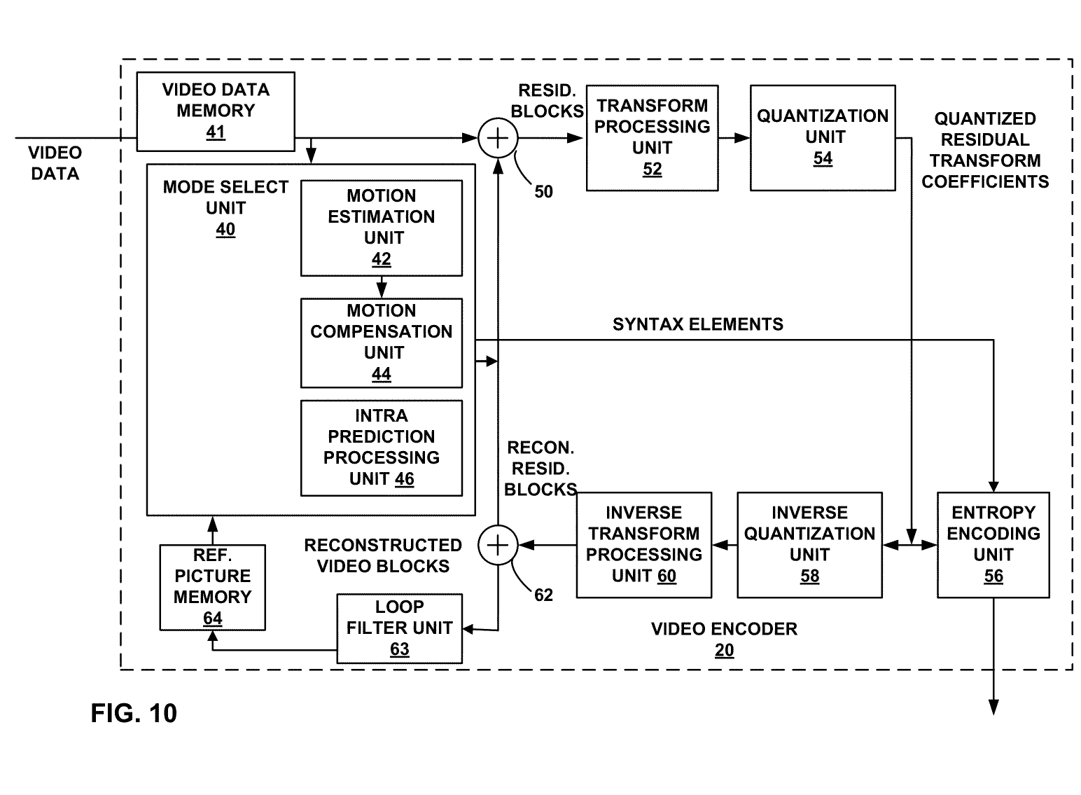

FIG. 10 is a block diagram illustrating an example of video encoder 20 that may implement the techniques of this disclosure. Video encoder 20 may perform intra- and inter-coding (including inter-view coding) of video blocks within video slices, e.g., slices of both texture images and depth maps. Texture information generally includes luminance (brightness or intensity) and chrominance (color, e.g., red hues and blue hues) information. In general, video encoder 20 may determine coding modes relative to luminance slices, and reuse prediction information from coding the luminance information to encode chrominance information (e.g., by reusing partitioning information, intra-prediction mode selections, motion vectors, or the like). Intra-coding relies on spatial prediction to reduce or remove spatial redundancy in video within a given video frame or picture. Inter-coding relies on temporal prediction to reduce or remove temporal redundancy in video within adjacent frames or pictures of a video sequence. Intra-mode (I mode) may refer to any of several spatial based coding modes. Inter-modes, such as uni-directional prediction (P mode) or bi-prediction (B mode), may refer to any of several temporal-based coding modes.

As shown in FIG. 10, video encoder 20 receives a current video block (that is, a block of video data, such as a luminance block, a chrominance block, or a depth block) within a video frame (e.g., a texture image or a depth map) to be encoded. In the example of FIG. 10, video encoder 20 includes video data memory 41, mode select unit 40, reference picture memory 64, summer 50, transform processing unit 52, quantization unit 54, loop filter unit 63, and entropy encoding unit 56. Mode select unit 40, in turn, includes motion compensation unit 44, motion estimation unit 42, intra-prediction processing unit 46, and partition unit 48. For video block reconstruction, video encoder 20 also includes inverse quantization unit 58, inverse transform processing unit 60, and summer 62. Loop filter unit 63 may include a deblocking filter and an SAO filter to filter block boundaries to remove blockiness artifacts from reconstructed video. In addition, loop filter unit 63 may be configured to perform loop filtering, including SEO filtering, on reconstructed depth maps, as described above. Additional filters (in loop or post loop) may also be used in addition to the deblocking filter. Such filters are not shown for brevity, but if desired, may filter the output of summer 50 (as an in-loop filter).

Video data memory 41 may store video data to be encoded by the components of video encoder 20. The video data stored in video data memory 41 may be obtained, for example, from video source 18. Reference picture memory 64 is one example of a decoding picture buffer (DPB that stores reference video data for use in encoding video data by video encoder 20 (e.g., in intra- or inter-coding modes, also referred to as intra- or inter-prediction coding modes). Video data memory 41 and reference picture memory 64 may be formed by any of a variety of memory devices, such as dynamic random access memory (DRAM), including synchronous DRAM (SDRAM), magnetoresistive RAM (MRAM), resistive RAM (RRAM), or other types of memory devices. Video data memory 41 and reference picture memory 64 may be provided by the same memory device or separate memory devices. In various examples, video data memory 41 may be on-chip with other components of video encoder 20, or off-chip relative to those components.

During the encoding process, video encoder 20 receives a video frame or slice to be coded. The frame or slice may be divided into multiple video blocks. Motion estimation unit 42 and motion compensation unit 44 perform inter-predictive coding of the received video block relative to one or more blocks in one or more reference frames to provide temporal prediction. Intra-prediction processing unit 46 may alternatively perform intra-predictive coding of the received video block relative to one or more neighboring blocks in the same frame or slice as the block to be coded to provide spatial prediction. Video encoder 20 may perform multiple coding passes, e.g., to select an appropriate coding mode for each block of video data.

Moreover, partition unit 48 may partition blocks of video data into sub-blocks, based on evaluation of previous partitioning schemes in previous coding passes. For example, partition unit 48 may initially partition a frame or slice into LCUs, and partition each of the LCUs into sub-CUs based on rate-distortion analysis (e.g., rate-distortion optimization). Mode select unit 40 may further produce a quadtree data structure indicative of partitioning of an LCU into sub-CUs. Leaf-node CUs of the quadtree may include one or more PUs and one or more TUs.

Mode select unit 40 may select one of the coding modes, intra or inter, e.g., based on error results, and provides the resulting intra- or inter-coded block to summer 50 to generate residual block data and to summer 62 to reconstruct the encoded block for use as a reference frame. Mode select unit 40 also provides syntax elements, such as motion vectors, intra-mode indicators, partition information, and other such syntax information, to entropy encoding unit 56.

Motion estimation unit 42 and motion compensation unit 44 may be highly integrated, but are illustrated separately for conceptual purposes. Motion estimation, performed by motion estimation unit 42, is the process of generating motion vectors, which estimate motion for video blocks. A motion vector, for example, may indicate the displacement of a PU of a video block within a current video frame or picture relative to a predictive block within a reference frame (or other coded unit) relative to the current block being coded within the current frame (or other coded unit).

A predictive block is a block that is found to closely match the block to be coded, in terms of pixel difference, which may be determined by sum of absolute difference (SAD), sum of square difference (SSD), or other difference metrics. In some examples, video encoder 20 may calculate values for sub-integer pixel positions of reference pictures stored in reference picture memory 64. For example, video encoder 20 may interpolate values of one-quarter pixel positions, one-eighth pixel positions, or other fractional pixel positions of the reference picture. Therefore, motion estimation unit 42 may perform a motion search relative to the full pixel positions and fractional pixel positions and output a motion vector with fractional pixel precision.

Motion estimation unit 42 calculates a motion vector for a PU of a video block in an inter-coded slice by comparing the position of the PU to the position of a predictive block of a reference picture. The reference picture may be selected from a first reference picture list (List 0) or a second reference picture list (List 1), each of which identify one or more reference pictures stored in reference picture memory 64. The reference picture lists may be constructed using the techniques of this disclosure. Motion estimation unit 42 sends the calculated motion vector to entropy encoding unit 56 and motion compensation unit 44.

Motion compensation, performed by motion compensation unit 44, may involve fetching or generating the predictive block based on the motion vector determined by motion estimation unit 42. Again, motion estimation unit 42 and motion compensation unit 44 may be functionally integrated, in some examples. Upon receiving the motion vector for the PU of the current video block, motion compensation unit 44 may locate the predictive block to which the motion vector points in one of the reference picture lists. Summer 50 forms a residual video block by subtracting pixel values of the predictive block from the pixel values of the current video block being coded, forming pixel difference values, as discussed below. In general, motion estimation unit 42 performs motion estimation relative to luma components, and motion compensation unit 44 uses motion vectors calculated based on the luma components for both chroma components and luma components. In this manner, motion compensation unit 44 may reuse motion information determined for luma components to code chroma components such that motion estimation unit 42 need not perform a motion search for the chroma components. Mode select unit 40 may also generate syntax elements associated with the video blocks and the video slice for use by video decoder 30 in decoding the video blocks of the video slice.

Intra-prediction processing unit 46 may intra-predict a current block, as an alternative to the inter-prediction performed by motion estimation unit 42 and motion compensation unit 44, as described above. In particular, intra-prediction processing unit 46 may determine an intra-prediction mode to use to encode a current block. In some examples, intra-prediction processing unit 46 may encode a current block using various intra-prediction modes, e.g., during separate encoding passes, and intra-prediction processing unit 46 (or mode select unit 40, in some examples) may select an appropriate intra-prediction mode to use from the tested modes.

For example, intra-prediction processing unit 46 may calculate rate-distortion values using a rate-distortion analysis for the various tested intra-prediction modes, and select the intra-prediction mode having the best rate-distortion characteristics among the tested modes. Rate-distortion analysis generally determines an amount of distortion (or error) between an encoded block and an original, unencoded block that was encoded to produce the encoded block, as well as a bit rate (that is, a number of bits) used to produce the encoded block. Intra-prediction processing unit 46 may calculate ratios from the distortions and rates for the various encoded blocks to determine which intra-prediction mode exhibits the best rate-distortion value for the block.

After selecting an intra-prediction mode for a block, intra-prediction processing unit 46 may provide information indicative of the selected intra-prediction mode for the block to entropy encoding unit 56. Entropy encoding unit 56 may encode the information indicating the selected intra-prediction mode. Video encoder 20 may include in the transmitted bitstream configuration data, which may include a plurality of intra-prediction mode index tables and a plurality of modified intra-prediction mode index tables (also referred to as codeword mapping tables), definitions of encoding contexts for various blocks, and indications of a most probable intra-prediction mode, an intra-prediction mode index table, and a modified intra-prediction mode index table to use for each of the contexts.

Video encoder 20 forms a residual video block by subtracting the prediction data from mode select unit 40 from the original video block being coded. Summer 50 represents the component or components that perform this subtraction operation. Transform processing unit 52 applies a transform, such as a discrete cosine transform (DCT) or a conceptually similar transform, to the residual block, producing a video block comprising residual transform coefficient values. Transform processing unit 52 may perform other transforms which are conceptually similar to DCT. Wavelet transforms, integer transforms, sub-band transforms or other types of transforms could also be used. In any case, transform processing unit 52 applies the transform to the residual block, producing a block of residual transform coefficients.

The transform may convert the residual information from a pixel value domain to a transform domain, such as a frequency domain. Transform processing unit 52 may send the resulting transform coefficients to quantization unit 54. Quantization unit 54 quantizes the transform coefficients to further reduce bit rate. The quantization process may reduce the bit depth associated with some or all of the coefficients. The degree of quantization may be modified by adjusting a quantization parameter. In some examples, quantization unit 54 may then perform a scan of the matrix including the quantized transform coefficients. Alternatively, entropy encoding unit 56 may perform the scan.

Following quantization, entropy encoding unit 56 entropy codes the quantized transform coefficients. For example, entropy encoding unit 56 may perform context adaptive variable length coding (CAVLC), context adaptive binary arithmetic coding (CABAC), syntax-based context-adaptive binary arithmetic coding (SBAC), probability interval partitioning entropy (PIPE) coding or another entropy coding technique. In the case of context-based entropy coding, context may be based on neighboring blocks. Following the entropy coding by entropy encoding unit 56, the encoded bitstream may be transmitted to another device (e.g., video decoder 30) or archived for later transmission or retrieval.

Inverse quantization unit 58 and inverse transform processing unit 60 apply inverse quantization and inverse transformation, respectively, to reconstruct the residual block in the pixel domain, e.g., for later use as a reference block. Motion compensation unit 44 may calculate a reference block by adding the residual block to a predictive block of one of the frames of reference picture memory 64. Motion compensation unit 44 may also apply one or more interpolation filters to the reconstructed residual block to calculate sub-integer pixel values for use in motion estimation. Summer 62 adds the reconstructed residual block to the motion compensated prediction block produced by motion compensation unit 44 to produce a reconstructed video block for storage in reference picture memory 64. The reconstructed video block may be used by motion estimation unit 42 and motion compensation unit 44 as a reference block to inter-code a block in a subsequent video frame.

Video encoder 20 may encode depth maps in a manner that substantially resembles coding techniques for coding luminance components, albeit without corresponding chrominance components. For example, intra-prediction processing unit 46 may intra-predict blocks of depth maps, while motion estimation unit 42 and motion compensation unit 44 may inter-predict blocks of depth maps. However, as discussed above, during inter-prediction of depth maps, motion compensation unit 44 may scale (that is, adjust) values of reference depth maps based on differences in depth ranges and precision values for the depth ranges. For example, if different maximum depth values in the current depth map and a reference depth map correspond to the same real-world depth, video encoder 20 may scale the maximum depth value of the reference depth map to be equal to the maximum depth value in the current depth map, for purposes of prediction. Additionally or alternatively, video encoder 20 may use the updated depth range values and precision values to generate a view synthesis picture for view synthesis prediction, e.g., using techniques substantially similar to inter-view prediction.

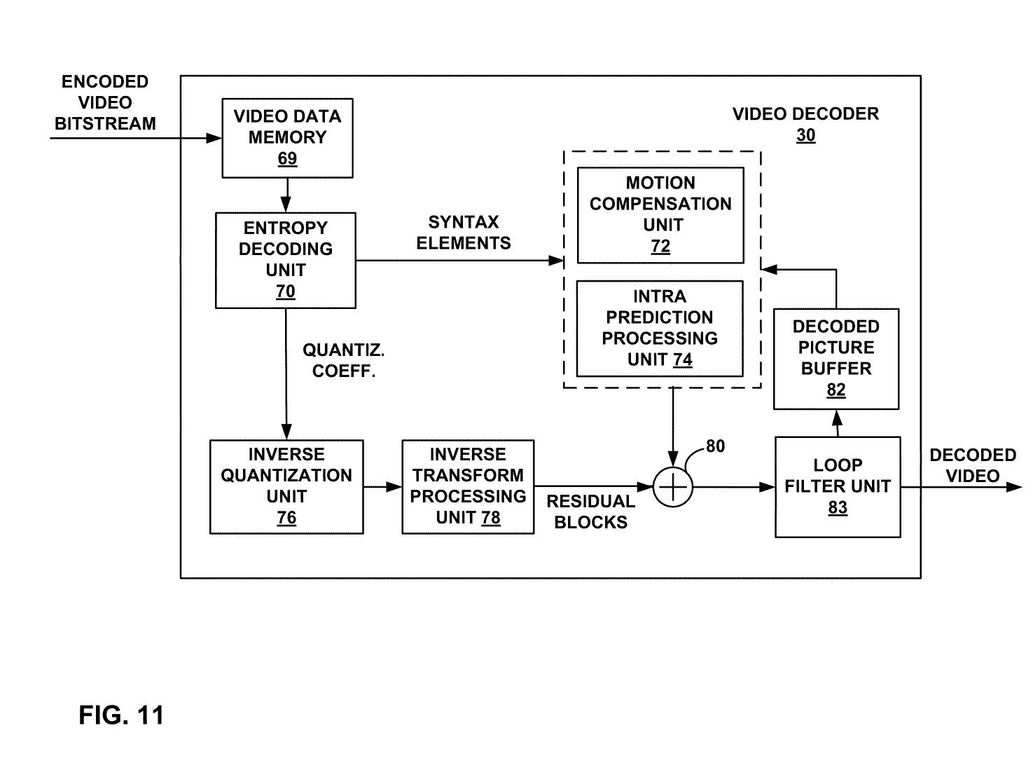

FIG. 11 is a block diagram illustrating an example of video decoder 30 that may implement the techniques of this disclosure. In the example of FIG. 11, video decoder 30 includes video data memory 69, entropy decoding unit 70, motion compensation unit 72, intra prediction processing unit 74, inverse quantization unit 76, inverse transformation unit 78, decoded picture buffer 82, loop filter unit 83, and summer 80. Video decoder 30 may, in some examples, perform a decoding pass generally reciprocal to the encoding pass described with respect to video encoder 20 (FIG. 10). Motion compensation unit 72 may generate prediction data based on motion vectors received from entropy decoding unit 70, while intra-prediction processing unit 74 may generate prediction data based on intra-prediction mode indicators received from entropy decoding unit 70.

Video data memory 69 may store video data, such as an encoded video bitstream, to be decoded by the components of video decoder 30. The video data stored in video data memory 69 may be obtained, for example, from storage device 34, from a local video source, such as a camera, via wired or wireless network communication of video data, or by accessing physical data storage media. Video data memory 69 may form a coded picture buffer (CPB) that stores encoded video data from an encoded video bitstream. Decoded picture buffer 82 is one example of a decoding picture buffer (DPB) that stores reference video data for use in decoding video data by video decoder 30 (e.g., in intra- or inter-coding modes, also referred to as intra- or inter-prediction coding modes). Video data memory 69 and DPB 82 may be formed by any of a variety of memory devices, such as dynamic random access memory (DRAM), including synchronous DRAM (SDRAM), magnetoresistive RAM (MRAM), resistive RAM (RRAM), or other types of memory devices. Video data memory 69 and DPB 82 may be provided by the same memory device or separate memory devices. In various examples, video data memory 69 may be on-chip with other components of video decoder 30, or off-chip relative to those components.

During the decoding process, video decoder 30 receives an encoded video bitstream that represents video blocks of an encoded video slice and associated syntax elements from video encoder 20. Entropy decoding unit 70 of video decoder 30 entropy decodes the bitstream to generate quantized coefficients, motion vectors or intra-prediction mode indicators, and other syntax elements. Entropy decoding unit 70 forwards the motion vectors to and other syntax elements to motion compensation unit 72. Video decoder 30 may receive the syntax elements at the video slice level and/or the video block level.

When the video slice is coded as an intra-coded (I) slice, intra prediction processing unit 74 may generate prediction data for a video block of the current video slice based on a signaled intra prediction mode and data from previously decoded blocks of the current frame or picture. When the video frame is coded as an inter-coded (i.e., B, P or GPB) slice, motion compensation unit 72 produces predictive blocks for a video block of the current video slice based on the motion vectors and other syntax elements received from entropy decoding unit 70. The predictive blocks may be produced from one of the reference pictures within one of the reference picture lists. Video decoder 30 may construct the reference frame lists, List 0 and List 1, using the techniques of this disclosure based on reference pictures stored in decoded picture buffer 82. Motion compensation unit 72 determines prediction information for a video block of the current video slice by parsing the motion vectors and other syntax elements, and uses the prediction information to produce the predictive blocks for the current video block being decoded. For example, motion compensation unit 72 uses some of the received syntax elements to determine a prediction mode (e.g., intra- or inter-prediction) used to code the video blocks of the video slice, an inter-prediction slice type (e.g., B slice, P slice, or GPB slice), construction information for one or more of the reference picture lists for the slice, motion vectors for each inter-encoded video block of the slice, inter-prediction status for each inter-coded video block of the slice, and other information to decode the video blocks in the current video slice.

Motion compensation unit 72 may also perform interpolation based on interpolation filters. Motion compensation unit 72 may use interpolation filters as used by video encoder 20 during encoding of the video blocks to calculate interpolated values for sub-integer pixels of reference blocks. In this case, motion compensation unit 72 may determine the interpolation filters used by video encoder 20 from the received syntax elements and use the interpolation filters to produce predictive blocks.

Inverse quantization unit 76 inverse quantizes, i.e., de-quantizes, the quantized transform coefficients provided in the bitstream and decoded by entropy decoding unit 70. The inverse quantization process may include use of a quantization parameter QP_{Y} calculated by video decoder 30 for each video block in the video slice to determine a degree of quantization and, likewise, a degree of inverse quantization that should be applied.

Inverse transform processing unit 78 applies an inverse transform, e.g., an inverse DCT, an inverse integer transform, or a conceptually similar inverse transform process, to the transform coefficients in order to produce residual blocks in the pixel domain.

After motion compensation unit 72 generates the predictive block for the current video block based on the motion vectors and other syntax elements, video decoder 30 forms a decoded video block by summing the residual blocks from inverse transform processing unit 78 with the corresponding predictive blocks generated by motion compensation unit 72. Summer 90 represents the component or components that perform this summation operation. Loop filter unit 63 may include a deblocking filter and an SAO filter to filter block boundaries to remove blockiness artifacts from reconstructed video. In addition, loop filter unit 63 may be configured to perform the loop filtering techniques of this disclosure, including edge detection and SEO filtering as described on above, on reconstructed depth maps. Additional filters (in loop or post loop) may also be used in addition to the deblocking filter. Such filters are not shown for brevity, but if desired, may filter the output of summer 80 (as an in-loop filter). The decoded video blocks in a given frame or picture are then stored in decoded picture buffer 82, which stores reference pictures used for subsequent motion compensation. Decoded picture buffer 82 also stores decoded video for later presentation on a display device, such as display device 32 of FIG. 1.

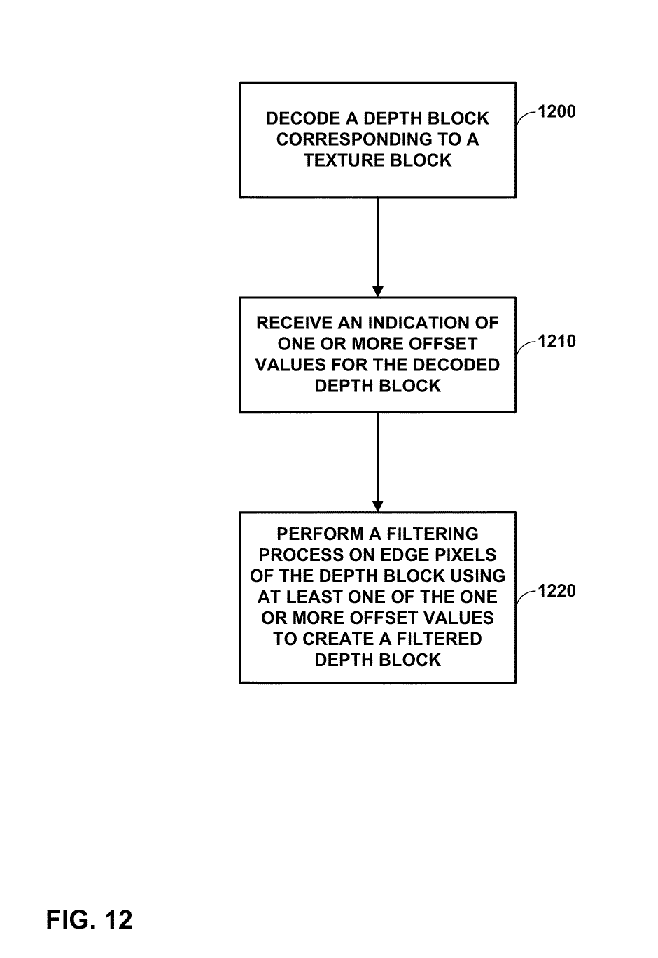

FIG. 12 is a flowchart showing an example encoding process according to the techniques of the disclosure. The techniques of FIG. 12 may be implemented by one or more structural units of video encoder 20, including loop filter unit 63.

In one example of the disclosure, video decoder 30 may be configured to decode a depth block corresponding to a texture block (1200), receive a respective indication of one or more offset values for the decoded depth block (1210), and perform a filtering process on edge pixels of the depth block using at least one of the one or more offset values to create a filtered depth block (1220). In one example of the disclosure, video decoder 30 may be configured to receive the respective indication for the one or more offset values in at least one of a slice segment layer header or a coding tree unit (CTU) header.

In one example of the disclosure, performing the filtering process on the edge pixels comprises adding at least one offset value of the one or more offset values to the edge pixels.

In another example of the disclosure, video decoder 30 may be configured to identify edge pixels in the depth block using the following techniques. Video decoder 30 may be configured to decode the texture block corresponding to the decoded depth block, detect one or more edges in the texture block, and designate one or more pixels in the depth block as edge pixels in the case that one or more edges are detected in the texture block, wherein the designated edge pixels in the depth block correspond to detected edge pixels in the texture block. In another example of the disclosure, video decoder 30 may be configured to detect one or more edges in the texture block by performing at least one of detecting one or more horizontal edges, detecting one or more vertical edges, or detecting one or more horizontal and vertical edges. In another example of the disclosure, video decoder 30 may be configured to detect one or more edges in the texture block by using a Sobel operator.

In another example of the disclosure, video decoder 30 may be configured to classify the edge pixels into one or more edge categories. In this regard, the filtering process may be a sample edge offset (SEO) filtering process, and video decoder 30 may be configured to receive the respective indication of the one or more offset values for each of the one or more edge categories in the SEO filtering process.

In another example of the disclosure, video decoder 30 may be further configured to decode the texture block, and synthesize one or more additional views of texture video data using the filtered depth block and the texture block.

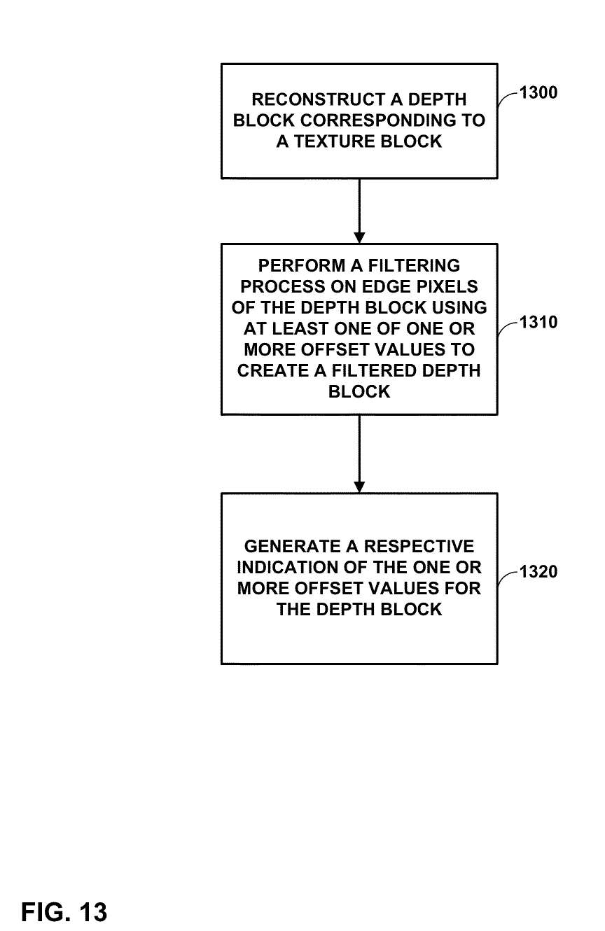

FIG. 13 is a flowchart showing an example decoding process according to the techniques of the disclosure. The techniques of FIG. 11 may be implemented by one or more structural units of video decoder 30, including loop filter unit 63.

In one example of the disclosure, video encoder 20 may be configured to reconstruct a depth block corresponding to a texture block (1300), perform a filtering process on edge pixels of the depth block using at least one of one or more offset values to create a filtered depth block (1310), and generate a respective indication of the one or more offset values for the depth block (1320). Video encoder 20 may be configured to generate the respective indication for the one or more offset values in at least one of a slice segment layer header or a coding tree unit (CTU) header.

Video encoder 20 may be further configured to perform a view synthesis optimization process using the filtered depth block at least one of a slice level or a block level. Video encoder 20 may also be further configured to perform a rate-distortion optimization process using the filtered depth block at least one of a slice level or a block level.

In one example of the disclosure, video encoder 20 may be configured to perform the filtering process on the edge pixels by adding at least one offset value of the one or more offset values to the edge pixels. Video encoder 20 may be further configured to perform the filtering process on the reconstructed depth block by detecting one or more edges in the texture block, and designating one or more pixels in the depth block as edge pixels in the case that one or more edges are detected in the texture block, wherein the designated edge pixels in the depth block correspond to detected edge pixels in the texture block. In one example of the disclosure, detecting one or more edges in the texture block comprises at least one of detecting one or more horizontal edges, detecting one or more vertical edges, or detecting one or more horizontal and vertical edges. In another example of the disclosure, video encoder 20 may be configured to detect one or more edges in the texture block using a Sobel operator.

In another example of the disclosure, video encoder 20 may be configured to classify the edge pixels into one or more edge categories. In another example of the disclosure, the filtering process is a sample edge offset (SEO) filtering process, and video encoder 20 may be further configured to generate the respective indication of the one or more offset values for each of the one or more edge categories in the SEO filtering process.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of decoding video data, the method comprising:
decoding a depth block corresponding to a texture block;
receiving a respective indication of one or more offset values for the decoded depth block; and
performing a filtering process on edge pixels of the depth block using at least one of the one or more offset values to create a filtered depth block.

2. The method of claim 1, wherein performing the filtering process on the edge pixels comprises adding at least one offset value of the one or more offset values to the edge pixels.

3. The method of claim 1, wherein the respective indication for the one or more offset values is received in at least one of a slice segment layer header or a coding tree unit (CTU) header.

4. The method of claim 1, further comprising:
decoding the texture block corresponding to the decoded depth block, and wherein performing the filtering process on the depth block comprises:
detecting one or more edges in the texture block; and
designating one or more pixels in the depth block as edge pixels in the case that one or more edges are detected in the texture block, wherein the designated edge pixels in the depth block correspond to detected edge pixels in the texture block.

5. The method of claim 4, wherein detecting one or more edges in the texture block comprises at least one of detecting one or more horizontal edges, detecting one or more vertical edges, or detecting one or more horizontal and vertical edges.

6. The method of claim 4, wherein detecting one or more edges in the texture block comprises detecting one or more edges in the texture block using a Sobel operator.

7. The method of claim 1, further comprising:
classifying the edge pixels into one or more edge categories.

8. The method of claim 7, wherein the filtering process is a sample edge offset (SEO) filtering process, and wherein receiving the respective indication of the one or more offset values comprises receiving the respective indication of the one or more offset values for each of the one or more edge categories in the SEO filtering process.

9. The method of claim 1, further comprising:
decoding the texture block; and
synthesizing one or more additional views of texture video data using the filtered depth block and the decoded texture block.

10. A method of encoding video data, the method comprising:
reconstructing a depth block corresponding to a texture block;
performing a filtering process on edge pixels of the depth block using at least one of one or more offset values to create a filtered depth block; and
generating a respective indication of the one or more offset values for the depth block.

11. The method of claim 10, further comprising:
performing a view synthesis optimization process using the filtered depth block at least one of a slice level or a block level.

12. The method of claim 10, further comprising:
performing a rate-distortion optimization process using the filtered depth block at least one of a slice level or a block level.

13. The method of claim 10, wherein performing the filtering process on the edge pixels comprises adding at least one offset value of the one or more offset values to the edge pixels.

14. The method of claim 10, wherein the respective indication for the one or more offset values is generated in at least one of a slice segment layer header or a coding tree unit (CTU) header.

15. The method of claim 10, wherein performing the filtering process on the reconstructed depth block comprises:
detecting one or more edges in the texture block; and
designating one or more pixels in the depth block as edge pixels in the case that one or more edges are detected in the texture block, wherein the designated edge pixels in the depth block correspond to detected edge pixels in the texture block.

16. The method of claim 15, wherein detecting one or more edges in the texture block comprises at least one of detecting one or more horizontal edges, detecting one or more vertical edges, or detecting one or more horizontal and vertical edges.

17. The method of claim 15, wherein detecting one or more edges in the texture block comprises detecting one or more edges in the texture block using a Sobel operator.

18. The method of claim 10, further comprising:
classifying the edge pixels into one or more edge categories.

19. The method of claim 18, wherein the filtering process is a sample edge offset (SEO) filtering process, and wherein generating the respective indication of the one or more offset values comprises generating the respective indication of the one or more offset values for each of the one or more edge categories in the SEO filtering process.

20. An apparatus configured to decode video data, the apparatus comprising:
a memory configured to store video data, including at least a depth block and a texture block; and
a video decoder configured to:
decode the depth block corresponding to the texture block;
receive a respective indication of one or more offset values for the decoded depth block; and
perform a filtering process on edge pixels of the depth block using at least one of the one or more offset values to create a filtered depth block.

21. The apparatus of claim 20, wherein the video decoder is further configured to add at least one offset value of the one or more offset values to the edge pixels.

22. The apparatus of claim 20, wherein the video decoder is further configured to receive the respective indication for the one or more offset values in at least one of a slice segment layer header or a coding tree unit (CTU) header.

23. The apparatus of claim 20, wherein the video decoder is further configured to:
decode the texture block corresponding to the decoded depth block, and wherein performing the filtering process on the depth block comprises:
detect one or more edges in the texture block; and
designate one or more pixels in the depth block as edge pixels in the case that one or more edges are detected in the texture block, wherein the designated edge pixels in the depth block correspond to detected edge pixels in the texture block.

24. The apparatus of claim 23, wherein the video decoder is further configured to detect one or more edges in the texture block by at least one of detecting one or more horizontal edges, detecting one or more vertical edges, or detecting one or more horizontal and vertical edges.

25. The apparatus of claim 23, wherein the video decoder is further configured to detect one or more edges in the texture block using a Sobel operator.

26. The apparatus of claim 20, wherein the video decoder is further configured to:
classify the edge pixels into one or more edge categories.

27. The apparatus of claim 26, wherein the filtering process is a sample edge offset filtering process, and wherein the video decoder is further configured to receive the respective indication of the one or more offset values for each of the one or more edge categories in the SEO filtering process.

28. The apparatus of claim 20, wherein the video decoder is further configured to:
decode the texture block; and
synthesize one or more additional views of texture video data using the filtered depth block and the decoded texture block.

29. An apparatus configured to decode video data, the apparatus comprising:
means for decoding a depth block corresponding to a texture block;
means for receiving a respective indication of one or more offset values for the decoded depth block; and
means for performing a filtering process on edge pixels of the depth block using at least one of the one or more offset values to create a filtered depth block.

30. The apparatus of claim 29, wherein the means for performing the filtering process on the edge pixels comprises means for adding at least one offset value of the one or more offset values to the edge pixels.
